(19) United States
(12) Patent Application Publication
(10) Pub. No.: US 2013/0311954 A1
(43) Pub. Date: Nov. 21, 2013

(54) EFFICIENT USER INTERFACE

(71) Applicant: GEEGUI CORPORATION, Helsinki (FI)

(72) Inventor: Sami Minkkinen, Helsinki (FI)

(73) Assignee: GEEGUI CORPORATION, Helsinki (FI)

(21) Appl. No.: 13/832,106

(22) Filed: Mar. 15, 2013

Related U.S. Application Data
(60) Provisional application No. 61/718,727, filed on Oct. 26, 2012.
(60) Provisional application No. 61/648,622, filed on May 18, 2012.

(51) Int. Cl. G06F 3/0481

(52) U.S. Cl. CPC G06F 3/04812
USPC 715/862

(57) ABSTRACT

There is described herein a compact, efficient, browsable, and self-revealing method and tool for command selection. The command selection includes a wide breadth and an implicitly learned expert mode. In addition, there are described herein efficient methods and tools for modifying the selected command and for selecting scope to which the selected command is applied.

### BACKGROUND OF THE INVENTION

A computing device, in general terms, is a programmable electronic device designed for performing prescribed operations on data, or on information. External information can be entered into a computing device by pointing. In general terms, pointing is showing the position of something. There are numerous different ways of performing pointing. For example, pointing can be performed with a finger, with a physical intermediary (such as a stylus), and with a pointing device (such as a mouse).

Graphical user interfaces (GUIs) are generally controlled by pointing. Common tasks performed by pointing in GUIs are selection of objects and computer commands along with actions related to commands, such as specification of command parameters, or arguments. A computer command is an instruction to a computing device to perform a specific task. Commands are commonly represented by command widgets, such as items in linear menus or buttons in a toolbar. When pointing is performed by a mouse, selection of a command is achieved by pointing to the representative widget, that is, within the borders of widget, and clicking one of the mouse buttons. An object is generally any item that can be individually selected and manipulated. Commonly a command is applied to the selected object, or objects. Therefore, object selection and command selection are commonly performed in combination. In addition, command parameters are commonly specified along with commands.

It is desirable that the above-mentioned tasks can be performed effectively, especially with commonly used commands. In addition, effective controlling should be learned fast. Furthermore, effective controlling should be learned implicitly, that is, while using the controlling mode designed for a novice operator, or simply novice mode. The effective controlling mode designed for an expert operator is called expert mode. Also, the footprint (or screen real estate) required for controlling should be as compact as possible without, however, increasing time and errors in pointing. This makes it more convenient to control, for example, a computer system with lots of commands. Or, a computing device with a small display, like a mobile phone or a tablet. Additionally, novice mode should be self-revealing, that is, visualization should describe what commands are available. Furthermore, controlling should suit the particular hardware provided by a computing device and exploit the possibilities of the hardware.

As far as controlling by pointing is concerned, current user interfaces are predominantly based on windows, linear menus, and buttons. While this traditional paradigm is self-revealing after the basic rules of interaction are explained to an operator, it does not fit the other objectives mentioned above.

Firstly, the traditional paradigm is not effective. A major disadvantage is that round trips are frequently performed between the working area and command widgets (such as linear menus and buttons on a toolbar). More specifically, the operator selects objects (for example, words from a text document) with a pointing device in the working area first, then selects a command (for example, Copy) from a command widget, and finally returns to the working area. Objects are predominantly worked on in the middle areas of the display while command widgets are close to the edges of the display, resulting in round trips. For example, copy-pasting a word requires two round trips. In addition to round trips between objects and commands, there are often round trips for parameter adjustment as well.

Secondly, the traditional paradigm does not have an implicitly learned expert mode. Keyboard shortcuts (for example, Ctrl-C for the Copy command) are commonly implemented for some commands in computer applications in order to make the traditional paradigm more effective. Keyboard shortcuts effectively eliminate round trips with the implemented commands Keyboard shortcuts can be thought of as an expert mode of the traditional paradigm. However, this expert mode is not implicitly learned. More specifically, the gesture in expert mode (for example, pressing the buttons Ctrl and C) is completely different from the gesture in novice mode (for example, selecting the Copy command from the Edit menu using a pointing device). Furthermore, there is a mismatch between a large number of needed commands in complicated applications and a rather limited number of keys. Mapping lots of commands to the keyboard is impractical, and it quickly becomes quite confusing and difficult to remember.

Thirdly, the traditional paradigm is not compact. Perhaps this is the reason why linear menus are located near the edges of display in the first place (resulting in the round trips described above). In this way, it is assured that there is enough space available for displaying a linear menu, that is, towards the middle of display from near the edge of display. The assurance of enough space applies also to context-sensitive linear menus which occupy only a quarter of the possible directions in respect of the pointed-at location when the menu pops up. Then, even a context-sensitive linear menu is initiated close to the edge of the display, or the edges of the display, so that there is enough available space for displaying the linear menu.

Finally, the traditional paradigm does not suit touch screen-equipped devices very well or, at least, it does not exploit the possibilities of the hardware to the full extent. Controlling based on a touch screen is becoming increasingly common for devices such as mobile phones and tablets. While there are some commands which can be implemented in a more “natural” way, for example rotation and zoom using two pointed locations (enabled by multi-touch), or page scroll or page change using vertical or horizontal gestures, there are numerous commands which are artificial, or abstract. More specifically, abstract commands don't have any role model in human interaction with physical objects, or with other humans, which would help to design natural gestures for them. The common solution is to describe abstract commands with words and place the description in a linear menu, or possibly in a hierarchical linear menu where the commands are grouped according their relationship. However, linear menus have the problems described above. Particularly, small mobile devices require a compact paradigm. In addition, keyboard shortcuts are inconvenient in touch screen-equipped devices because of their small keyboards, or even impossible if they lack a keyboard. Furthermore, a study report that stroke shortcuts, which are constructed by pointing, are learned much better than keyboard shortcuts, even if users didn't benefit from implicit learning.

### SUMMARY OF THE INVENTION

It is an object of the present invention to provide a method for selecting a command in a user interface.

It is an aspect of certain embodiments of the present invention to provide a method which includes at least some of the steps of; tracking the movement trajectory of a user input, recognizing a reverse crossing within the movement trajectory, and determining a command based on at least a portion of the movement trajectory prior to the recognized reverse crossing.

Furthermore, it is an object of the present invention to provide a computer readable medium, transitory and/or non-transitory in nature, for storing computer readable instructions for carrying out the methods described herein.

According to certain embodiments of the present invention there is herein described a compact, efficient, browsable, and self-revealing command selection. The command selection includes a wide breadth (the wider the breadth is, the more can be selected without making too many errors) and an implicitly learned expert mode.

It is an object of certain embodiments of the present invention to remove, or effectively reduce, round trips. This can be achieved because of compactness. More specifically, because of compactness, there is no need to take the pointed-at location near the edges of display in order to assure enough space for command selection. In other words, commands can be selected in close vicinity to the pointed-at location when needed. Furthermore, compactness enables selection even if there are tight space requirements for inputting. This is the case, for example, with small touch screens which are becoming an increasingly common way inputting information into mobile devices.

Certain embodiments of the present invention utilize pointing which, as mentioned above, can be performed by an operator in numerous ways. The variation over time of the pointed-at location can be used to construct the “movement trajectory”. A movement trajectory begins and ends as indicated by an operator, and tracks the pointed-at location between these two terminal events.

An aspect of certain embodiments of the present invention involves control elements, which are associated with a hierarchical system. Another aspect of certain embodiments of the present invention involves determining a top item of the hierarchical system wherein the first crossing over a control element by the movement trajectory after the command phase is initiated is adequate information for determination. A top item is an item which doesn't have superior items in the hierarchical system. Another aspect of certain embodiments of the present invention involves determining a subordinate item to the top item wherein the way of crossing over the control element preceding the “selective action” is adequate information for determination. Therefore, an operator can select the intended top item of the hierarchical system by crossing the right control element and subsequently selecting the intended subordinate item to the top item by performing a selective action after crossing the right control element in the correct way. In other words, a top item can be selected without a selective action, which enhances operation. On the other hand, a selective action required with subsequent selections enables more compact interface and, with the right selective actions, enhances operation as well.

A selective action can be any action performed by an operator. However, convenient and fast selective actions include ending the movement trajectory and the reverse crossing, another aspect of certain embodiments of the present invention. Reverse crossing means that the operator reverses the movement trajectory and crosses back over the same control element in the opposite direction.

A further aspect of certain embodiments of the present invention is that when a terminal item, or a command in some embodiments, becomes determined by a selective action, execution of the command will depend on the manner of the selective action. A terminal item is an item which doesn't have subordinate items in a hierarchical system. If the selective action is ending the movement trajectory, a default execution of the command may follow. For example, in the default execution, the command is executed with default parameters (or arguments), or with the most common parameters. If the selective action is a reverse crossing, a modifying phase for the command may follow.

An aspect of certain embodiments of the present invention involves the modifying phase where the default execution of the command is modified in some way before the modifying phase is ended by ending the movement trajectory. For example, in the modifying phase, a parameter, or parameters, of the command are modified. When the modifying phase is ended, the command is executed along with modifications.

Still other aspects of certain embodiments of the present invention involve a convenient and compact arrangement of control elements, or line segments in some embodiments.

Another aspect of certain embodiments of the present invention involves associating items of a hierarchical system with control elements and with a way of crossing in such a way that commonly-used commands are very fast to select, while the modifying phase and traversing in the hierarchical system are convenient to perform.

Another aspect of certain embodiments of the present invention involves a combination of scope selection and command selection in a single continuous movement trajectory where a reversal separates the two selections. A reversal results when a substantial length of movement trajectory becomes substantially reversed. An operator is proficient at constructing a reversal.

An aspect of certain embodiments of the present invention involves a computationally efficient recognition algorithm for reversals. The recognition algorithm functions even if the movement trajectory is adversely sampled and it contains unintentional spikes or if the reversals are imperfect.

Another aspect of certain embodiments of the present invention involves a different kind of feedback to assist an operator.

Another aspect of certain embodiments of the present invention involves a layout for selecting characters and commands.

Another aspect of certain embodiments of the present invention involves a device having variety of aspects of the present invention.

### BRIEF DESCRIPTION OF THE DRAWINGS

FIG. 1A and FIG. 1B illustrate that a reversal is something that an operator is proficient at constructing by pen.

FIG. 2 illustrates how the true position of a movement trajectory can be adversely sampled.

FIG. 3 illustrates two extreme cases of reversals.

FIG. 4 illustrates reversal recognition in accordance with an example of the invention.

FIG. 5 illustrates reversal recognition in accordance with an example of the invention.

FIG. 6 illustrates an unintentional sharp spike within the movement trajectory along with computer sampling.

FIG. 7 illustrates a reversal containing an unintentional small loop structure along with adverse computer sampling.

FIG. 8 illustrates how selection of items is enabled in accordance with an example of the invention.

FIG. 9A, FIG. 9B, and FIG. 9C illustrate the effectiveness of an example of the invention.

FIG. 10A and FIG. 10B illustrate the effectiveness of an example of the invention along with a compact arrangement of control elements.

FIG. 11 illustrates four movement trajectories which are results of selecting the same sequence of items four times in accordance with an example of the invention.

FIG. 12 illustrates a root menu in accordance with an example of the invention.

FIG. 13A and FIG. 13B illustrate how the selection of the command Edit>Copy is enabled in accordance with an example of the invention.

FIG. 14A illustrates how the selection of the command View>Back is enabled in accordance with an example of the invention.

FIG. 14B illustrates how modifying the default execution of the View>Back command is enabled in accordance with an example of the invention.

FIG. 15A and FIG. 15B illustrate how continuous parameter modification is enabled along with the command View>Zoom in accordance with an example of the invention.

FIG. 16A, FIG. 16B, FIG. 16C, and FIG. 16D illustrate how selection of items in subsequent levels of a hierarchical system is enabled in accordance with an example of the invention.

FIG. 17A and FIG. 17B illustrate how scope selection, command selection and the modifying phase are enabled in accordance with an example of the invention.

FIG. 18 illustrates how scope selection is enabled, in accordance with an example of the invention, when scope selection is based on crossing the intended objects.

FIG. 19 illustrates a simplified high-level flowchart for scope selection, command phase and modifying phase in accordance with an example of the invention wherein the command phase is illustrated for novice mode.

FIG. 20 illustrates the top level of the hierarchical system and, in detail, the part of the hierarchical system represented in FIG. 16A, FIG. 16B, FIG. 16C, and FIG. 16D.

FIG. 21 illustrates an example environment 2100 in accordance with an example of the invention.

FIG. 22 illustrates how an operator can indicate whether the movement trajectory begins with scope selection in accordance with an example of the invention.

FIG. 23 illustrates a layout for selecting characters and commands in accordance with an example of the invention.

FIG. 24 illustrates the beginning of a command selection with the layout illustrated in FIG. 23 in accordance with an example of the invention.

FIG. 25A, FIG. 25B, and FIG. 25C illustrate a computing device having efficient user interface in accordance with an example of the invention.

### DETAILED DESCRIPTION OF EXEMPLARY EMBODIMENTS

Pointing can be performed by an operator in numerous ways. The variation over time of the pointed-at location can be used to construct the “movement trajectory”. A movement trajectory begins and ends as indicated by an operator, and tracks the pointed-at location between these two terminal events.

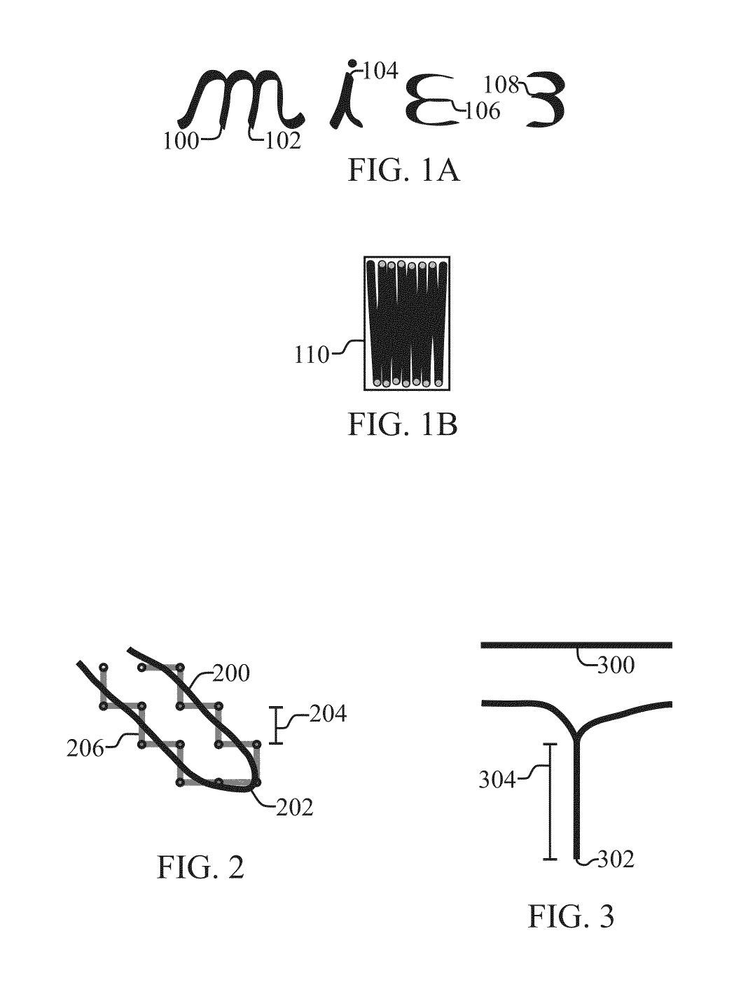

A reversal results when a substantial length of movement trajectory becomes substantially reversed. A reversal has a tip point: the likely point where reversing has begun. Commonly, the direction of the movement trajectory has the largest change at the tip point. FIG. 1A and FIG. 1B illustrate that a reversal is something that an operator is proficient at constructing by pen. FIG. 1A shows the letters “m” and “i” with cursive letters as well as epsilon and the number “3”. In these four examples the operator has performed reversals having tip points at locations 100, 102, 104, 106, and 108. Therefore, the operator already has the motor skills for performing reversals in different directions if the operator has acquired Western handwriting skills. FIG. 1B illustrates a likely tactic for coloring in the area 110 by pen. This is an intuitive tactic and used comprehensively in coloring in tasks. Intuition can be seen, for example, by observing how children, who are just learning the motor skills for using a pen, color in areas in a coloring book. In FIG. 1B, the operator has performed numerous reversals having tip points at the locations marked with gray circles. Performing a reversal is very fast. One can demonstrate the fastness with pen and paper by coloring in an area as illustrated in FIG. 1B. The skills illustrated with FIG. 1A and FIG. 1B can be transferred to an example of the invention, resulting in fluent user adaption.

In addition to the examples in FIG. 1A and FIG. 1B, where an operator has produced “ink content”, movement trajectories in accordance with an example of the invention are used for control. In other words, ink content is not used for controlling by definition. Switching between ink content and controlling can be indicated by the operator (such as by pressing a button with the non-preferred hand).

As described below, a reversal can be recognized in accordance with an example of the invention. Moreover, recognition is accomplished substantially instantaneously, that is, just after an operator has performed a reversal and even while the operator is continuing the movement trajectory. In other words, the movement trajectory does not need to end in order for the reversals to be recognized in accordance with an example of the invention. Therefore, a reversal can have a substantial effect on program execution while the operator is continuing the movement trajectory. This, as described below, enables efficient and convenient control which otherwise wouldn't be possible.

Even though positions in human-made movement trajectories are inherently analogue, software to interpret movement trajectories has to deal with digital positions. Analogue positions are quantized into digital ones in computer sampling, which means that there is a fundamental loss of information. Sampling error, the difference between the true position and the sampled position, depends greatly on the properties of sensors and controlling hardware. Sampling error is usually perceived when a straight line is drawn diagonally in relation to the array of sensors. If there is a lot of sampling error, the resulting line looks jagged, or zig-zag. This is also called sampling aliasing, or prealiasing. For example, on touch screens, sampling error can be reduced by having a better signal-to-noise ratio in the touch sensors, by decreasing the sensor size, and by increasing the sampling rate, all of which most likely increase the price of a device. A better signal-to-noise ratio and smaller sensors require more accurate, and also more costly, manufacturing. Increased sampling requires more computing, which, in turn, requires more expensive hardware and consumes more power (undesirable on mobile devices). Therefore, it is desirable to have a movement trajectory interpreter which is robust to sampling error.

Reversal recognition is more vulnerable to sampling error than crossing recognition. Crossed control elements are likely to be so big compared to the sampling error that the sampling error is negligible. If a traditional user interface can be implemented in a specific hardware environment, recognizing crossings over control elements wouldn't be a problem in the same hardware environment. However, sampling error is an issue in reversal recognition.

One might think that curve approximation could offer a way to recognize reversals by finding curvatures which have a radius less than a predetermined value. However, the radius of curvature may be difficult, if not impossible, to compute when there are many inflexion points and high sampling error. In addition, approximation requires it to be possible to find curved segments and to fit a curve to the segments, which requires complex algorithms and extensive computing. This is unnecessary taking into account reversal recognition in accordance with an example of the invention. Also, a fitted curve doesn't directly tell the tip point of the reversal (see the example of tip points in FIG. 1) and, therefore, the tip point should be found with an additional algorithm. Finally, curve approximation in three-dimensional space is even more complex, if not impossible. However, reversal recognition in accordance with an example of the invention is easy to extend to three-dimensional space.

FIG. 2 illustrates how the true position of a movement trajectory can be adversely sampled. The true position of movement trajectory 200 is illustrated with a black trajectory and sampled points are illustrated with black dots. The movement trajectory constructs a reversal and it should be recognized as a reversal. The reversal has tip point 202, or the likely point where reversing has begun. Because the reversal can have a preferred role in embodiments of the invention, correct recognition of the tip point is desirable. In the illustration, the reversal is drawn diagonally, which can be a major source of sampling error. Although the illustration exaggerates sampling error compared to real cases, exaggeration better illustrates the power of the reversal recognition algorithm in accordance with an example of the invention. Even in this exaggerated case, the reversal can be recognized with the algorithm. The illustration is zoomed in to a level where the minimum distance 204 between the sensors, which defines the sensing resolution, is clearly shown. Taking into account the sensing resolution in modern hardware, an operator would hardly perceive the sensing resolution without zooming, if at all. The true position goes mostly diagonally through adjacent sensors so that sampled points come on both sides of the trajectory. The gray path in the figure is interpolation path 206 which is constructed by connecting successive sampled points with straight line segments. There is no additional sampling point between the sampled points on the interpolation path shown in the figure. Interpolation path 206 looks jagged because of adverse sampling.

In accordance with an example of the invention, the reversal recognition algorithm is based on fitness values calculated for sampled points. The fitness value represents, in inverse relationship, the likelihood of a given sampled point being the tip point of reversal. Because of the inverse relationship, the tip point is found at the sampled point where the fitness value reaches a minimum. One way to illustrate the foundation of the fitness value is to imagine movement trajectories becoming two extreme cases as illustrated in FIG. 3. On the top is a straight line on which point 300 (referring to a location on the straight line) is as far as possible from being the tip point of a reversal. On the bottom is the perfect reversal in which the movement trajectories at either side of tip point 302 are perfectly overlapping for length 304. A perfect reversal results when a substantial length of movement trajectory is perfectly reversed. When considering the perfectly overlapping part, the points being as far from the tip point 302 are on top of each other (by definition) and the distance between the points is zero. On the other hand, the points being as far from point 300 on a straight line are as far apart as possible. These two extreme cases give foundation to the fitness value based on the points being as far from a point under fitness calculation. When it comes to computer sampling and loss of information, the required robustness for the sampling error, as introduced above, is fulfilled by having several point pairs along the interpolation path for some length. The two points in a pair are as far from a point under fitness calculation but they are on different sides. Then, one natural fitness value would be the sum of distances between pairs of points. This sum-based fitness reaches a minimum in a perfect reversal, that is zero, and a maximum on a straight line. When the constructing scheme for constructing point pairs is known, the maximum fitness can be calculated by using the scheme and a straight line. Because the minimum and the maximum values for the fitness are known or calculable for the given constructing scheme, only one parameter between the extreme values can be predetermined in order to cut off unintentional noise from intentional reversals. This parameter is hereafter referred to as the “cut-off parameter”.

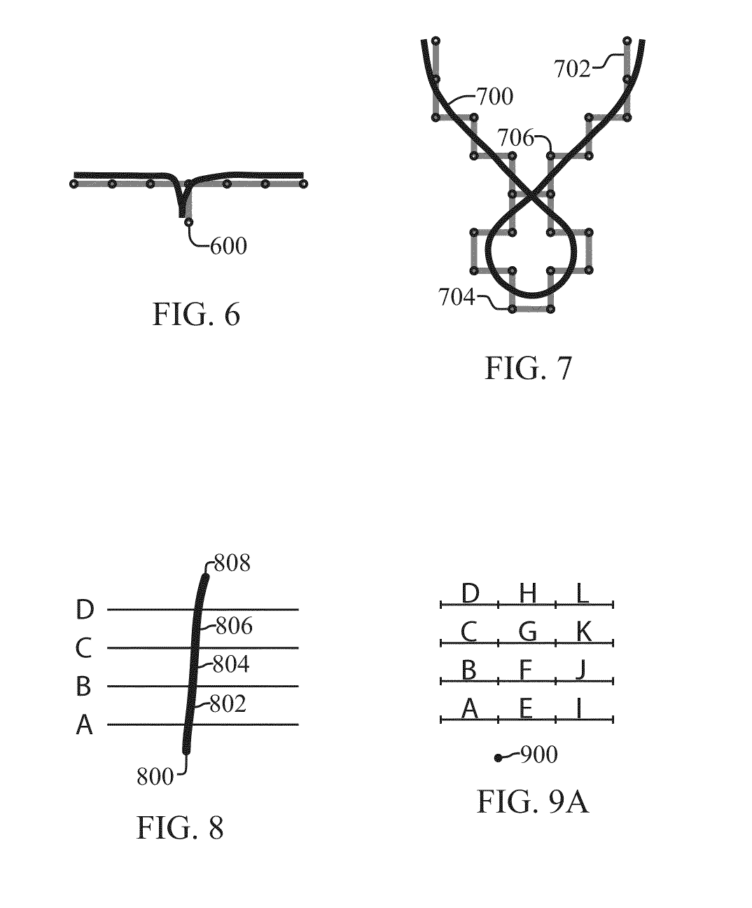

Even though there are numerous possible constructing schemes, the implemented scheme should require minimal computing resources. Good accuracy can be achieved with the following constructing scheme. The distance to the next interpolated point along the interpolation path, hereafter referred to as the “interpolation distance”, is constant. Furthermore, the overall interpolated length along the interpolation path, which defines how many point pairs are constructed, should be so long that unintentional spikes and noise aren't recognized as reversals. This is explained in more detail along with the illustration in FIG. 6. In addition, the overall interpolated length should be so long that an intentional reversal with a small loop structure can be recognized correctly. The reason for this becomes more apparent along with illustrations in FIG. 7.

On the other hand, the longer the overall interpolated length, the more point pairs are needed to be constructed for every point under fitness calculation (given a constant interpolation distance). This adversely affects the overall complexity of the algorithm. In addition, the longer the overall interpolated length, the longer part of the movement trajectory is needed for recognizing a reversal. This adversely affects the responsiveness of an example of the invention, that is, a response to found reversal can be given at later point after the tip point. This can have inconvenient consequences. Therefore, the overall interpolated length shouldn't be too long.

In a specific hardware environment the overall interpolated length can usually be predetermined by monitoring such small loops (by asking a test user to perform numerous reversals, finding small loops within reversals, and calculating the needed length). For example, for an accuracy of 0.010 inch and resolution of 1000 points per inch in sensing hardware, 8 point pairs and an interpolation distance equal to the width of a pixel on the display (10.4-inch display with 1024×768 resolution) works well.

The cut-off parameter can be predetermined in accordance with an example of the invention. Predetermination should take into account the fact that human motor skills are imperfect and, therefore, the user interface can't require perfect operation. Predetermination can be accomplished, for example, by user tests, given specific hardware. Also, an operator can adjust the parameter at will, reflecting the level of recognition of reversals between the best and the worst case. Note that allowing adjustment too close to the worst case marks everything as reversals, which effectively disables recognition in full. On the other hand, a cut-off parameter which is too strict requires reversals which are too perfect, which is undesirable because of the imperfect nature of human motor skills. Also, machine learning components can be used for learning, and for adjusting, the appropriate level from usage data.

While in some examples of the invention the preferred choice is a constant interpolation distance, in other examples of the invention it might be more advantageous to have a variable interpolation distance. A variable interpolation distance could depend on, for example, the distance from the sampled point under fitness calculation or the gesturing speed.

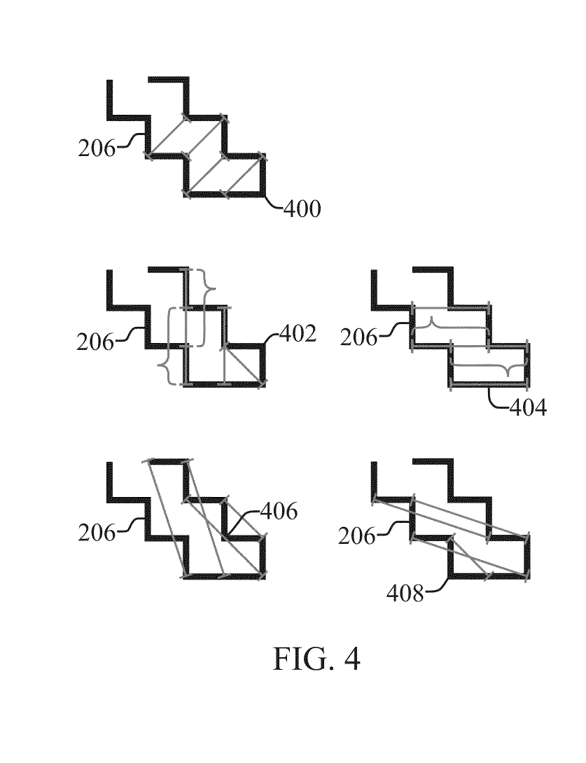

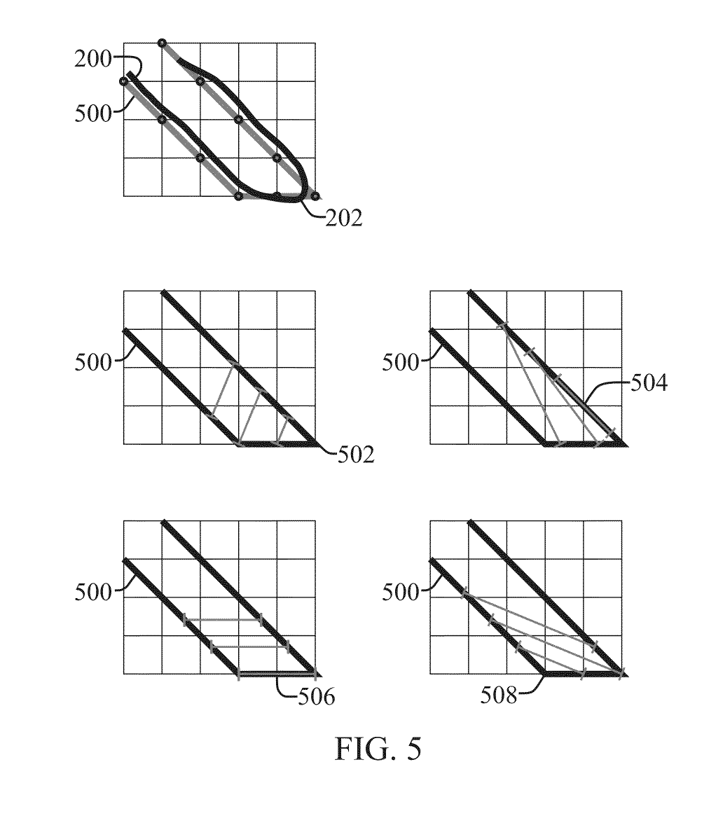

In order to find the tip point of a reversal the fitness value, as described above, should increase around the tip point even if reversals aren't performed perfectly. More specifically, in the case of computer sampling, the fitness value should be at minimum at the sampled point closest to the tip point. Further, the fitness value should increase monotonically at further on sampled points. Hence, there wouldn't be local minimums at nearby sampled points and the sampled point closest to the tip point is easier to define. This desirable behavior of the fitness value becomes apparent along with illustrations in FIG. 4 and FIG. 5 in accordance with an example of the invention. These figures also provide a more detailed description about interpolation, and about the reversal recognition algorithm in general.

FIG. 4 illustrates reversal recognition in accordance with an example of the invention. This illustration is based on interpolation path 206 illustrated in FIG. 2. As described above, interpolation path 206 is constructed by connecting successive sampled points with straight line segments. Sampled points are the result of computer sampling of the true position of movement trajectory 200, which constructs a reversal. See FIG. 2 for the locations of sampled points (illustrated with black dots). FIG. 4 illustrates the case where a fitness value is calculated for five different sampled points near tip point 202. It is preferred that the constructing scheme, defined by the interpolation distance and the number of point pairs, remains constant in every fitness calculation in order to maintain comparability. In FIG. 4 the interpolation distance is equal to minimum distance 204 between sensors and four point pairs are interpolated.

One can consider that the reversal in FIG. 2 differs from a perfect reversal in a way that the points, which were on top of each other in the perfect reversal, are torn apart for some length. The tearing has happened almost symmetrically in respect to tip point 202. Even though interpolation path 206 has strong aliasing because of sampling error, it reflects to some extent the symmetrical tearing in respect to sampled point 400 closest to tip point 202. The fitness value, calculated by summing the distances of point pairs (illustrated with the gray measuring line segments), reflects how extensive the tearing is. That is, how far apart the points, which are on top of each other in the perfect reversal, are torn. On the other hand, when calculating the fitness value for sampled points further on from the tip point, the symmetry, which made the distance between point pairs low when considering the sampled point closest to the tip point, gradually vanishes. This tearing-based inference helps us to understand why the fitness value behaves as desired. The fitness values for five different sampled points provide evidence thereof.

Interpolation is easy in the five cases of FIG. 4 because the interpolation distance is the same as the distance between corners in the interpolation path, except in the lowest line segment which has a length of two times the interpolation distance. Beginning from the sampled point under fitness calculation, an interpolated point is in every location after the interpolation distance is traversed along the interpolation path. The two interpolation points being as far from the sampled point construct a point pair. In FIG. 4 the distances between points in a pair are illustrated with gray measuring line segments, at the end of which are point pairs. In two cases, measuring line segments adversely becomes partly over each other. In these cases the length of the individual measuring line segment is shown with an additional gray curly bracket.

Sampled point 400, which is closest to tip point 202, is the most beneficial in accordance with the symmetry. In the illustrated sampling this also means that all four distances between points in a pair are equal, that is 2^{1/2}, where 2^{1/2} means the square root of 2. Therefore, the fitness value, or sum of distances, is 5.66. At the neighboring sampled points, the symmetry has already been lost a little bit, resulting in bigger fitness values. At sampled point 402 the fitness value is 7.41 (=2^{1/2}+2+2+2). At sampled point 404 the fitness value is 8.00 (=2+2+2+2). At the most distant illustrated sampled points the symmetry is lost even more, resulting in the biggest fitness values. At sampled point 406 the fitness value is 10.57 (=2^{1/2}+8^{1/2}+10^{1/2}+10^{1/2}). At sampled point 408 the fitness value is 10.90 (=2^{1/2}+10^{1/2}+10^{1/2}+10^{1/2}).

These five fitness values illustrate the strength of fitness value calculation in accordance with an example of the invention. That is, even in the presence of sampling error and with an imperfect reversal, the sampled point closest to the tip point is recognizable in accordance with an example of the invention. In addition, calculation is very simple. Therefore, no complex algorithms for finding curved segments and fitting a curve to the segments are needed. The maximum fitness value in this constructing scheme is 20 (=2*(1+2+3+4)). This can be derived by considering distances between interpolated points in a pair where points in a pair are 1, 2, 3, and 4 lengths away from some point on a straight line and, finally, summing the distances. Therefore, the lowest fitness value 5.66 is 28.28% of maximum fitness. Setting the cut-off parameter to 30%, the movement trajectory in FIG. 2 would be recognized as a reversal having a tip point at sampled point 400 in accordance with an example of the invention.

FIG. 5 illustrates reversal recognition in accordance with an example of the invention. This illustration gives a more detailed view of the interpolation. In the illustration, the same movement trajectory 200 is sampled with a different computer sampling scheme, resulting in different sampled points (illustrated with black dots). Interpolation path 500 is constructed by connecting successive sampled points with straight line segments. In order to make the illustration more readable, a rectangular grid is shown in FIG. 5. It is constructed by drawing straight line segments through the mid-points of sensors, or through the quantized positions outputted by sensing hardware in computer sampling and, therefore, the gaps between these lines represent the minimum distance between sensors, which is also set as the interpolation distance. To make the following description simpler, the interpolation distance is set to 1. Three point pairs are interpolated.

One convenient way to calculate interpolation points is to use vectors pointing to the location of the next sampled point from the current sampled point. These vectors are constructed along the interpolation path beginning from the sampled point under fitness calculation. Later these vectors are denoted by p₁.

When sampled point 504 is under fitness calculation, the first three vectors, beginning to the south-east direction, are p₁=[1, −1], p₂=[−1, 0], and p₃=[−1, 0]. In order to show a clearer example, in the following calculation the origin is set to the sampled point under fitness calculation. Naturally this is not necessary in the actual algorithm. The first interpolated point I₁ can be calculated by simply multiplying unit vector p₁/|p₁| by the interpolation distance, that is 1, resulting in I₁: (2^{-1/2}, 2^{-1/2}). The calculation of the second interpolation point I₂ exemplifies the factors which should be addressed in the interpolating algorithm. More specifically, the first interpolation point is before the sampled point (1, −1) and it takes a length of 2^{1/2}−1 to reach the sampled point. Therefore, and because the points are interpolated along interpolation path 500 defined by sampled points, a length of 2^{1/2}−1 is already traversed when at sampled point (1, −1). Then, the position vector of the second interpolation point can be calculated by going from sampled point (1, −1), positioned by a vector [1, −1], in the direction of p₂ with the length left at the current interpolation distance, or mathematically [1, −1]+(1−(2^{1/2}−1))*(p₂/|p₂|)=[1, −1]+(2−2^{1/2})[−1, 0]=[−1+2^{1/2}, −1], or I₂: (−1+2^{1/2}, −1). The other factor which should be addressed in the interpolating algorithm is that there might be several sampling points before the next interpolation point is reached, depending on the interpolation distance, of course. In this case too, the algorithm has to keep track of the distance traversed along the path defined by several sampled points so that the overall distance traversed is the interpolation distance on the next interpolation point. The solution to the second interpolation point calculation can be used to calculate the third interpolation point I₃. That is, the length left at the current interpolation distance is {1−[1−(2−2^{1/2})]}=2−2^{1/2}, where excessive parentheses are used to indicate deduction order, resulting in the position vector of the third interpolation point as [0, −1]+(2−2^{1/2})*(p₃/|p₃|)=[−2+2^{1/2}, −1], or I₃: (−2+^{1/2}, −1).

In a similar way can be interpolated points in the north-west direction from sampled point 504 under fitness calculation. After that, point pairs can be constructed. Then, distances between points in a pair can be calculated by Pythagoras' theorem. For sampled point 504 the distances are 2.00, 3.03, and 3.48, resulting in a fitness value, or sum of distances, of 8.51. For sampled point 502 the distances are 0.77, 1.53, and 1.53, resulting in a fitness value of 3.83. For sampled point 506 the distances are 2.00, 2.00, and 2.00, resulting in a fitness value of 6.00. For sampled point 508 the distances are 1.85, 3.70, and 3.70, resulting in a fitness value of 9.25. Clearly the fitness value reaches a minimum at sampled point 502, which is the closest sampled point to tip point 202. Notice that determination of the tip point is based on sampled points and, in this particular sampling, sampled point 502 is the more likely tip point than sampled point 506, which is also close to tip point 202.

FIG. 6 illustrates an unintentional sharp spike within the movement trajectory along with computer sampling. The movement trajectory (illustrated with a black trajectory) in FIG. 6 is an example where the intention of an operator was to accomplish a straight movement trajectory but the trajectory contains an unintentional spike. The unintentional spike can be caused, for example, by the inaccuracy of human motor skills or unsteadiness in environment (e.g. the operator is in a moving vehicle). Whatever the reason, unintentional spikes and noise should be distinguished from reversals by the recognition algorithm. In accordance with an example of the invention, reversals can be recognized correctly even in the presence of noise and unintentional spikes as long as the overall interpolated length is predetermined appropriately, taking into account the hardware environment.

For example, in the case presented in FIG. 6, if the interpolation distance is 1 and the number of point pairs is 1, the fitness value for sampled point 600 is 0.00 (because the interpolation points in the pair are in the same location). The fitness value for a reversal couldn't be less, because the fitness value is at a minimum, and the unintentional sharp spike is recognized as a reversal with a tip point at sampled point 600. Therefore, the short overall interpolated length results in a recognition error.

However, this recognition error can be corrected by increasing the overall interpolated length, or by having more interpolated point pairs if the interpolation distance is kept constant. For example, if the interpolation distance is kept at 1 and the number of point pairs is increased from 1 to 6, the relative fitness value at sampled point 600 increases as follows: 0% (for 1 point pair), 33%, 50%, 60%, 67%, and 71% (for 6 point pairs). The relative fitness value relates the fitness value to the maximum fitness so that 0% is equivalent to the minimum fitness and 100% is equivalent to the maximum fitness. Because the unintentional sharp spike should not be recognized as a reversal, a higher percentage is, in this case, better. For example, if three interpolation points are used, the recognition error can be fixed by setting the cut-off parameter to 25% (50%>25% and, therefore, the unintentional sharp spike is not recognized as a reversal).

FIG. 7 illustrates a reversal containing an unintentional small loop structure along with adverse computer sampling. Reversal movement trajectories can have a small loop structure at the tip end, as illustrated in FIG. 7. The reason for a small loop structure is the imperfect nature of human motor skills. Therefore, a small loop structure should not prevent the algorithm from recognizing a reversal. However, if the overall interpolated length is long enough, a reversal with a small loop structure at the tip end can be recognized in accordance with an example of the invention. As previously, true movement trajectory 700 is illustrated with a black trajectory and sampled points are illustrated with black dots. Interpolation path 702 (illustrated with gray) is constructed by connecting successive sampled points with straight line segments. Sampling has excessive error in order to illustrate the power of recognition in accordance with an example of the invention. In practice this kind of sampling error is unlikely.

Table 1 presents relative fitness values in different constructing schemes for all sampled points along interpolation path 702 from sampled point 704 (the bottom row in the table) to sampled point 706 (the top row in the table). The interpolation distance is constant and is the same as the distance between neighboring sampled points along the interpolation path. However, the number of point pairs changes from 5 to 12 (columns in the table). Relative fitness values are reported for sampled points in the table as long as it is possible to calculate values given the length of interpolation path 702. Because sampled point 704 is almost at the middle of interpolation path 702, it has more relative fitness values (up to 12 point pairs) than the others. Note that interpolation path 702 is vertically symmetrical. Therefore, relative fitness values are applicable to vertically symmetric sampled points. Hence, the relative fitness values for all sampled points in the small loop, if calculable, are presented in Table 1.

If the cut-off parameter is predetermined to 25%, relative fitness values highlighted in bold in Table 1 are below the cut-off parameter. Therefore, in accordance with an example of the invention, the movement trajectory in FIG. 7 is recognized as a reversal if there are at least 6 point pairs, given that the cut-off parameter is predetermined as 25%. Even though relative fitness values generally decrease with an increasing number of point pairs, there is a more rapid decrease for sampled point 704 when one more point pair is added to the 5 point pairs. Actually, when considering sampled point 704, the points in the 6^{th} point pair are in the same location and having 6 point pairs doesn't increase the sum of the distances, while the maximum fitness value will increase. The same location can be verified by counting sampled points, which are also the locations of interpolated points, both directions from sampled point 704 in FIG. 7. This reflects the design guideline mentioned above; that is, the overall interpolated length should be so long that an intentional reversal with a small loop structure can be recognized correctly. If the overall interpolated length along the constructed interpolated path is so long that interpolation will go around a small loop, interpolated point pairs will begin to be close to each other which, in turn, will cause relative fitness to decrease more rapidly.

Also in small loop structures gradually vanishing symmetry will increase the fitness value at sampled points further on from the tip point. This can be seen in terms of the gradually increasing relative fitness values in Table 1 when considering the constant constructing scheme, or a column in the table, and sampled points further on from the tip point, or upper rows. It is remarkable that the gradual increase is smooth, even in the presence of adverse sampling error and with an imperfect reversal.

Note that the cut-off parameter will determine how big the loop is allowed to be in a reversal. Unintentional loops are small because constructing such loops intentionally is beyond the pointing accuracy of humans. However, an operator can construct bigger intentional loops and recognizing such loops as reversals can have erroneous consequences (depending on the implementation of the invention). In practice, an appropriate cut off parameter along with a constructing scheme can be predetermined by monitoring the size of loops in the reversals with unintentional loop structures.

TABLE 1
Relative fitness values

| At sampled | Number of point pairs | | | | | | | |
|---|---|---|---|---|---|---|---|---|
| point | 5 | 6 | 7 | 8 | 9 | 10 | 11 | 12 |
| 706 | 71.18 | | | | | | | |
| : | 62.63 | 64.65 | | | | | | |
| : | 62.63 | 64.65 | 63.43 | | | | | |
| : | 56.59 | 51.07 | 47.41 | 43.95 | | | | |
| : | 48.59 | 44.23 | 38.82 | 36.40 | 34.09 | | | |
| : | 39.13 | 32.71 | 30.18 | 27.40 | 26.64 | 25.65 | | |
| : | 33.00 | 28.33 | 23.77 | 22.42 | 21.45 | 21.62 | 21.40 | |
| 704 | 33.30 | 23.79 | 20.37 | 18.62 | 18.41 | 18.70 | 19.44 | 19.72 |

In some rare cases, the fitness value might reach a minimum in more than one neighboring sampled point. This can happen, for example, when two sampled points are as far from the tip point in a symmetrical reversal, as it is with sampled point 704 and its vertically symmetric sampled point. The relative fitness value for both sampled points is equal (for example 18.41 with nine point pairs, see Table 1). Even though the distance between the locations of two neighboring sampled points is most likely small, it is more convenient to represent the tip point of a reversal with one location, and not with two or more locations. Then, extra measures are needed in order to come up with one representative location. One possible solution is to select the location of the sampled point which comes first, or last, in terms of temporal order of a movement trajectory. Another solution is to select the mean location between two sampled points, which might be a more accurate representative location (assuming that the tip point is between the two sampled points).

When considering a set of successive sampled points which have fitness values below the cut-off parameter, in some rare cases the fitness value might reach a local minimum at more than one sampled point. In other words, in the set there is more than one sampled point which has a fitness value below the fitness values of its neighboring sampled points. In this case, the sampled point with a global minimum within the set should be selected. Generally, the search for the minimum fitness value and definition of the representative location can be based on all fitness values calculated for a movement trajectory, or it can be restricted to a set of fitness values. However, extra measures are needed only in very sparse computer sampling which, taking into account modern hardware development, would be rare.

Hardware development may lead to a computer sampling scheme where sampling is so dense that sampled points almost form an analogue trajectory or, in fact, movement trajectory is processed by a computing device in an analogue manner (for example by modeling movement trajectory with piecewise linear functions). In these cases, reversals can also have a meaning in accordance with an example of the invention. In addition, reversals can be recognized with a similar technique compared to more sparse sampling. However, it is most likely unnecessary to calculate a fitness value for every sampled point, particularly as there are potentially infinitely many sampled points. Instead, it would be sufficient to calculate fitness values after predetermined distances. Even if there are gaps between the locations where the fitness value is defined, reversals are recognizable according to an example of the invention, as described above. If gaps are too wide in terms of the precision required to recognize the tip point, a more accurate location can be iteratively sought from the nearby locations relative to the location of the minimum fitness value. An iterative search can be initiated if the tentative location has a fitness value close to the level set by the cut-off parameter, but not necessarily below it. In this way, it can be ensured to some extent that reversals are not missed, even if the fitness value is not calculated for every possible location provided by computer sampling.

As mentioned above, reversal recognition in accordance with an example of the invention is easy to extend to three-dimensional space (or even to higher-dimensional spaces). More specifically, in the case of three-dimensional space, the pointed-at location is three-dimensional (the operator points at a location in space), resulting in a three-dimensional movement trajectory. Then the sampled points, the interpolation path and the interpolation points are also three-dimensional. The Euclidean distance between the points can be calculated in three-dimensional space just as well as in two-dimensional space. In addition, the fitness values of a straight line and a perfect reversal, both of which are three-dimensional, set limits to possible fitness values and, therefore, the cut-off parameter can be predetermined.

FIG. 8 illustrates how selection of items is enabled in accordance with an example of the invention. An example of the invention enables selection, performed by an operator, based on crossings specified by selective actions. A selective action can be any action performed by an operator. In addition, a selective action can be performed before, during, or after crossing, depending on the implementation of the invention. However, because a crossing is specified by selective action, a selective action should be performed in such way that it can be directed to the intended crossing. For example, if a selective action is performed after crossing in an implementation of the invention, the selective action should be performed after the intended crossing but before a subsequent crossing because otherwise the subsequent crossing becomes specified.

FIG. 8 illustrates an example of the invention where a selective action is performed after crossing. In FIG. 8 there are four lines which are types of control element which can be crossed by a movement trajectory. Furthermore, four different items are associated with these lines as denoted on the left side of the lines, that is, items from A to D. While performing the movement trajectory beginning from location 800, an operator has performed a selective action (such as pressing a button with the non-preferred hand) three times when the movement trajectory was at locations 802, 804, and 806. This means that items from A to C, in that order, become determined as selected. In such an example the determination is carried out, in general terms, by seeking the preceding crossing over a control element by the movement trajectory in relation to the location of a selective action. When the preceding crossing is found, the associated item can be determined as selected.

Ending the movement trajectory, for example by lifting a pen up, can also be a selective action. Therefore, if so set, ending the movement trajectory at location 808 effectively selects associated item D.

The selective action can be a property of the movement trajectory itself. Such a property can be based on, for example, speed patterns or morphology. For example, a selective action can be a stopping movement for a predetermined time after crossing and performing such a selective action in locations 802, 804, and 806 effectively selects items from A to C.

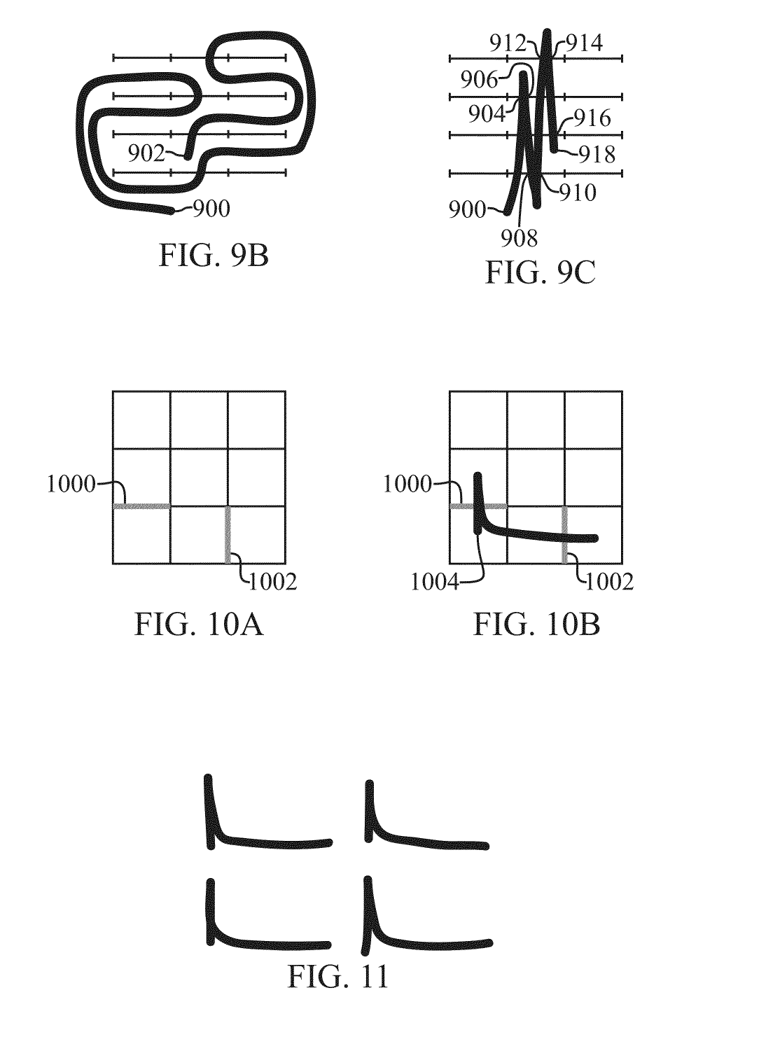

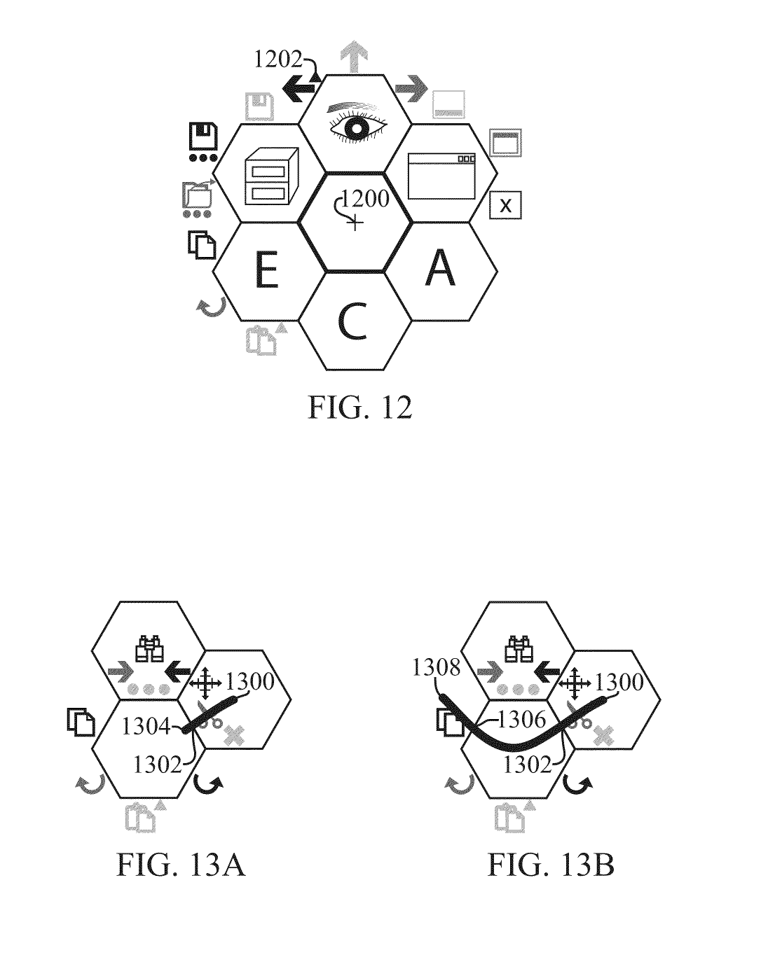

A particularly convenient selective action is a reverse crossing after a crossing. Reverse crossing means that the operator reverses the movement trajectory and crosses back over the same line in the opposite direction before crossing other lines. Reverse crossing is fast and convenient because it can be performed by making a reversal over the correct line. Furthermore, a reversal can become a natural property of the movement trajectory in order to modify the default execution of a commonly-used command or traverse a hierarchical system. This will become more apparent along with the examples of the invention described below (beginning from FIG. 12), and it is reflected, for example, in FIG. 9C.

FIG. 9A, FIG. 9B, and FIG. 9C illustrate the effectiveness of an example of the invention. The control elements in the figures are 12 straight line segments which have associated items denoted just above the line segments in FIG. 9A, that is, items from A to L. In this example, an operator intends to select items G, E, H, and F, in that order, with one continuous movement trajectory beginning from location 900.

FIG. 9B illustrates a resulting movement trajectory (from location 900 to location 902) when selection is merely based on cross-over. The resulting method is hereafter referred as “inevitable method”. Note that with the inevitable method, an operator has to be careful not to cross the wrong line segments while crossing the correct ones in the right order. This leads to a kind of maze where the operator has to use cognitive resources in order to find the path to the correct line segment. This extra inference will make execution slower. In addition, the longer and the narrower the tunnels in a maze are, the slower the execution.

FIG. 9C illustrates a resulting movement trajectory (from location 900 to location 918) in accordance with an example implementation of the invention. In such an example, selective actions are reverse crossings (at locations 906, 910, and 914) and ending the movement trajectory at location 918, all of which are performed after crossing the correct line segments in the right order (at locations 904, 908, 912, and 916). Note that ineffectiveness related to the inevitable method, that is, extra inference and steering through tunnels, is eliminated. This is achieved by allowing the operator to cross all line segments in accordance with an example of the invention.

FIG. 10A and FIG. 10B illustrate the effectiveness of an example of the invention along with a compact arrangement of control elements. Control elements in such an example are straight line segments. More line segments are achieved by also having vertical line segments, in addition to horizontal line segments. Moreover, crossings of vertical and horizontal line segments provide natural separation of line segments. Such crossings separate 24 different line segments in the figures.

Individual control elements can be crossed in different ways by a movement trajectory. Different items can be associated with different ways of crossing the control elements in accordance with an example of the invention. Different ways of crossing the control elements can be distinguished, for example, by the speed of crossing or by the angle of crossing. However, it is convenient to separate crossings in two based on from which side to which side a crossing is performed in relative to a control element. That is, for example with vertical line segments in the figures, from the left side to the right side or from the right side to the left side. Therefore, two different items can be associated with each line segment, which are further associated with two different ways of crossing.

Thus, altogether 48 different items can be associated with line segments in the arrangement illustrated in FIG. 10A (and in FIG. 10B) in accordance with an example of the invention. An example of the invention enables any item to be selected after any other item, with one continuous movement trajectory. This is not possible with inevitable methods when considering continuous movement trajectories. For example, after crossing line segment 1000 (emphasized with a thick, gray line) an operator cannot cross line segment 1002 (emphasized with a thick, gray line) without crossing other line segments in between, as would be necessary in an inevitable method. However, as illustrated in FIG. 10B, in accordance with an example of the invention, the movement trajectory beginning at location 1004 specifies such crossings because, after crossing line segment 1000, a reverse crossing is performed and after crossing line segment 1002, the movement trajectory is ended. In other words, the item associated with line segment 1000 and with crossing from down to up is selected first, and then the item associated with line segment 1002 and with crossing from left to right.

As mentioned above, altogether 48 different items can be selected in accordance with an example of the invention having the arrangement illustrated in FIG. 10A (and in FIG. 10B). This kind of compactness is remarkable when compared to the traditional user interface paradigm where touching an area, or clicking within an area, means selection of command. Issuing a command in traditional computer user interfaces is almost exclusively based on this old type of paradigm (think, for example, buttons, menus, toolbars). Vertical and horizontal line segments delimit nine different areas in FIG. 10A. Therefore, only nine commands, or items, can be selected if the traditional user interface paradigm is implemented. Hence, compared to the traditional user interface paradigm and with the arrangement in FIG. 10A, more than five times more items can be selected with an example of the invention. This ratio is even bigger when taking into account the exponential growth of items along with the increasing number of levels in a hierarchical system. Comparing hierarchical systems with three levels, the ratio is 48³/9³=110592/729=152.7 (can be derived, for example, by thinking that all 48 items have 48 sub-items which, in turn, all have 48 terminal items). This is a remarkable improvement. The sizes of the objects are at the same level even though one dimension is reduced. This suggests that the selection speed is about at the same level. Furthermore, an implementation of the invention can be designed so that mean distances between crossings becomes small. This can be accomplished by taking into account the frequency of command use in an application, which follows a Zipfian distribution. This means that most of the time an operator use only a small subset of all commands in an application and for this subset can be designed the fastest selections (for example, by minimizing distances between crossings). In addition, an example of the invention can be designed so that secondary constraint, related to selective actions, can be bypassed with the most commonly used commands. These points will become more apparent along with the examples of the invention described below.

Sequential selection of several items could be performed with a discontinued movement trajectory in order to jump over unwanted control elements. However, discontinuing has disadvantages. Firstly, because an operator has to articulate discontinuous parts, the selection process can become slower. For example, lifting a stylus up and setting it down again on a touch screen would require time. One can demonstrate this with the color in task illustrated in FIG. 1B. If in such of task pen is lifted up and set down again (instead of making fast reversal) near the boarders of the area to be colored in, there is a deep fall in the efficiency. In some cases the discontinuity articulation can be very slow and tedious, like in a ray-casting user interface (a special hand gesture for ray-casting is slow to articulate). Furthermore, in some cases the discontinuity articulation can be error prone, if not impossible. Take pointing based on rate control, for example, where a user input variable is mapped to the velocity of the pointed-at location, or cursor. Therefore, without additional means, pointing can't be moved over a control element without crossing it. That is, movement trajectory can't be ended before a control element and began again after the control elements without, for example, pressing a button. However, synchronizing such a button press with pointing is error prone, especially when an operator is trying to work quickly. Secondly, and more importantly in some implementations of the invention, the discontinuity articulation is an even worse disadvantage in expert mode, which is designed to be fast. If an operator performs slow discontinuity articulation in expert mode, the desired speed isn't achieved.

FIG. 11 illustrates four movement trajectories which are results of selecting the same sequence of items four times in accordance with an example of the invention. After performing the same selection enough times, the operator learns the movement trajectory itself for the sequence of items and can reproduce it quickly and without visualization. Therefore, movement trajectory is implicitly learned while making selection in novice mode, that is, with visualization of control elements. The constraints set by control elements can be seen as a way of teaching expert mode. In novice mode, movement trajectory is interpreted literally. Therefore, the operator has to be careful to make the correct crossings and selective actions which unnecessarily slow the performance of well learned movement trajectories. Whereas in expert mode, well learned movement trajectories can be performed quickly, without unnecessary spatial constraints set by control elements in comprehensive visualization in novice mode, and movement trajectories are recognized with machine learning algorithms. Recognition in expert mode allows some variations in movement trajectories (see the example of variation in FIG. 11). Because expert mode is designed for fast performance, it is critical that an operator can perform fast movement trajectories. Therefore, slow articulation of the discontinuous part will effectively cancel what is achieved with expert mode. Thus, continuous movement trajectories are advantageous, especially when a reverse crossing works as a selective action. For example, stopping movement for a predetermined time in the middle of the movement trajectory isn't a good selective action when fast performance is required, naturally. Also, pressing a button with the non-preferred hand isn't a good selective action either, because an operator would have problems synchronizing the button presses with the movement trajectory.

The following describes how common tasks can be enabled in accordance with certain examples of the invention.

FIG. 12 illustrates a root menu in accordance with an example of the invention. The root menu comprises control elements with which is associated a part of hierarchical system.

Control elements are line segments and they are placed on the edges of hexagons in the example. Therefore, control elements can be modeled with line equations and, therefore, it is computationally easy to check if a control element is crossed and which control element has been crossed. The command phase of the movement trajectory will begin from the center 1200 of the root menu. With a central design, the lengths of movement trajectories to, and over, the different control elements are minimized.

When considering a crossing specified by a subsequent selective action and the selective action should be performed within a hexagon, the directional constraint in crossing over a control element is less than the amplitude constraint for selective action. Or, in other words, the length of an edge is less than the diameter of hexagon orthogonal to the edge (the diameter is 1.73 times longer). This benefits interaction because humans are better at regulating directional error than amplitude error. Therefore, a hexagon is better than a square or triangle as a frame for placing control elements. There is another reason why a hexagon is a particularly good choice, related to chunking, which is described later. However, one of ordinary skill in the art will recognize that other shapes, and combinations of shapes, can be used with the same concepts as described herein with the present invention.

The big icons and letters within the outermost hexagons in the example of FIG. 12 represent groups of items and they construct the top level of the hierarchical system. A top item is an item at the top level. A top item is an item which doesn't have superior items in the hierarchical system. One hierarchical system can have several top items. Top items are associated with control elements surrounding the center 1200 of the root menu. At the top level are, beginning from the southwest hexagon relative to the center 1200 of the root menu, Edit (SW, letter E), File (NW), View (N), Window (NE), Application (SE, letter A), and Custom (S, letter C) groups as top items. In order to maximize skill transfer between different applications, File, Edit, View, and Window groups should be associated with equally placed control elements in different root menus. Both novice and expert modes will benefit from skill transfer. Commands which are application-specific and don't fit under those four groups would be under the Application group (for example different pen styles in a drawing application or different font styles in a writing application). In the Custom group, an operator can add his/her own commands.

Note that it may be more convenient to implement different, and application-specific, root menu for applications with very large command sets (like applications in computer-aided design and engineering) than operate through the Application top item presented in FIG. 12. Switching between different root menus can be initiated, for example, by a button pressed with the non-preferred hand or with a command in a menu.

The smaller icons outside of hexagons, and near the outermost control elements, represent computer commands in the present example. They represent (potentially) the three most commonly-used commands of each group in the top level (in other words, a part of sub-menus is visualized in the root menu, more below). In terms of the hierarchical system, commands are terminal items. In other words, a terminal item is an item which doesn't have subordinate items in the hierarchical system. Commands are associated with the control elements nearest to them. Altogether, 18 commands can be associated with the outermost control elements in the present example (when only one way of crossing is concerned). Given that the frequency of command use follows a Zipfian distribution, 18 commands can account for most command use if association is designed well. For example, in a study it was found that the 18 most frequently-used commands in a word processing application accounted for about 88% of all command usage.

Different colors, or different shades of the same color, can be used to distinguish different command representations. The icons representing commands, as well as other command representations, can be color coded according to the angle of the control elements (with which commands are associated) in order to give a clearer visualization. Colors are reflected as different shades of gray in the figures. The icons in the example of FIG. 12 represent the following commands (listed in clockwise order beginning from SE, distinguishing colors are given in parentheses): Edit>Paste (green), Edit>Undo (red), Edit>Copy (blue), File>Open . . . (red), File>Save As . . . (blue), File>Save (green), View>Back (blue), View>Up (green), View>Forward (red), Window>Minimize (green), Window>Maximize (red), and Window>Close (blue). Application and Custom groups don't have commands associated with the outermost control elements although they could have. Note that neighboring control elements have icons visualized with different colors which will make them easier to distinguish.

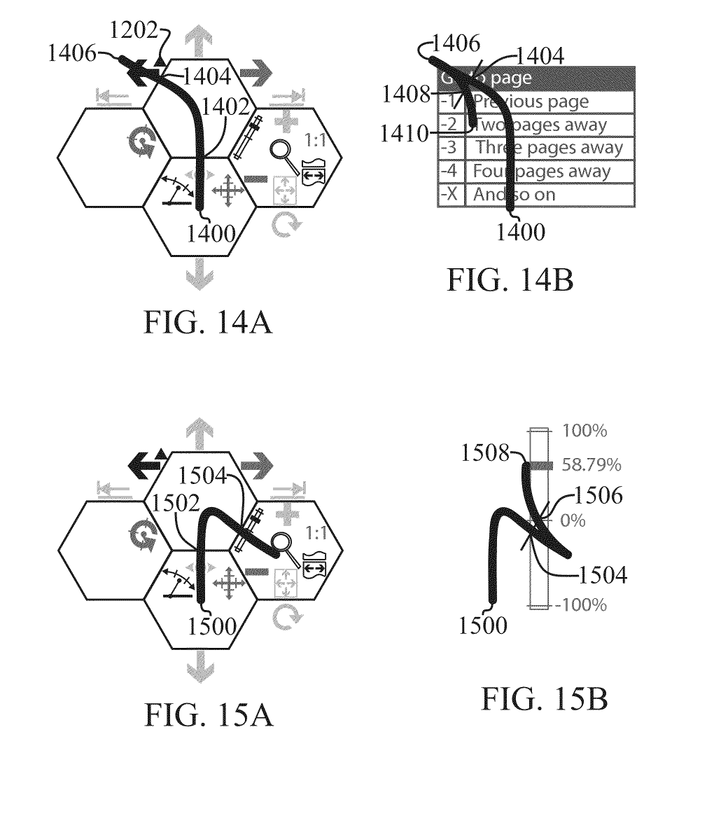

Control elements can have additional semantics, such as little triangles in FIG. 12. Little triangles indicate that there is a modifying phase for a command associated with the particular control element. More specifically, if a little triangle, or other similarly distinguishing mark, is on the same side as an icon representing a command (which is associated with the particular control element), then there can be a modifying phase for the command. For example, little triangle 1202 is on same side as the icon representing the View>Back command. Therefore, there is a modifying phase for the View>Back command (this is illustrated in FIGS. 14A and 14B).

Because the command phase of the movement trajectory begins from the center 1200 of the root menu in the present example, the control elements placed on the edges of the central hexagon are reachable without crossing other control elements. Therefore, the first crossing in the command phase can be set as a special case in accordance with an example of the invention. This special case enables an operator to select an item simply by making the first crossing, without performing a selective action. This is emphasized with thicker straight line segments around the center 1200 of the root menu in FIG. 12. Similarly, this can be signified in a number of other intuitive ways. Omitting an excess selective action in the special case enhances operation in both novice and expert modes. This is a further benefit of the central design, in addition to minimizing the lengths of movement trajectories (see above).

An example of the invention enables the selection of a top item in the hierarchical system by the first crossing over a control element after the command phase is initiated. In particular, no selective action is required after the first crossing in order to select a top item. There are several benefits in such an example. Firstly, if a command is selected by the first crossing, only very few commands can be selected, depending on how many control elements are reachable without crossing other control elements. Secondly, mere crossing is better for selecting a group of items, or a top item, than a command because a crossing can be unintentional. If the wrong top item is unintentionally selected, the selection can be aborted, because nothing is executed, and corrected in the following selection. In other words, selection of the wrong top item doesn't have irreversible consequences, as it could with selection of the wrong command Thirdly, given that commands, or terminal items in general, are subordinate items to top items in the hierarchical system, top items are selected most often. That is, every time a command is selected, a top item is selected first. Therefore, selecting a top item should be very fast, as it is with the example because, for example, no selective action is required. Finally, fast top item selection enables sub-menus to be displayed. The number of possible selections is multiplied along with the number of sub-menus.

When considering the arrangement of control elements placed on the frame consisting of seven tessellated hexagons, as illustrate in FIG. 12, a total of 60 different items can be associated. More specifically, there are 30 different control elements and each control element can be associated with two items which, in turn, can be associated with two different ways of crossing. When new associations are displayed, it is convenient for the novice user that no associations are visualized under the pointing finger in some examples of the invention (in the case where the movement trajectory is constructed by finger). Therefore, if the pointed-at location is within a hexagon when new associations are displayed in such of examples, there should be no associations visualized within the hexagon. This design guideline slightly reduces the potential number of associations to 54. However, when there are no visual obstructions, this design guideline may be unnecessary. For example, OpenOffice 3.1 has at most 24 menu items under its top-level menu items, but professional programs could have as many as 60. Therefore, the arrangement placed on the frame consisting of seven tessellated hexagons provides plenty of possible associations for most applications. If the required number of menu items is not achieved with seven hexagons, it is possible to add more hexagons. On the other hand, if fewer menu items are required, the number of hexagons can also be reduced (see FIG. 13A for example). As described above, after a top item is selected, a sub-menu is displayed. If there are 6 top items and each sub-menu enables the selection of 54 items, a total of 324 items can be selected in the novice mode of an example of the invention with a hierarchy of two levels. If one more level is added, 17,496 (=324*54) items can be selected. Note that even if the number of levels is increased, control elements can be placed on the frame consisting of seven tessellated hexagons. Therefore, the overall area required for performing selections remains constant.

According to an example of the invention, the first crossing over a control element after the command phase is initiated provides adequate information for determining the top item to be traversed to. The first crossing can be monitored, for example, in the following way. Every time the movement trajectory changes, the example of the invention checks if any of the control elements placed on the edges of the central hexagon (hereafter referred as “central control elements”) is crossed. Because the central control elements are straight line segments in the present example, checking is easy to accomplish with six straight lines going through the end points of six straight line segments (when a line segment is part of a corresponding line). Straight lines are easily defined with line equations Ax+By +C=0, where constants A, B, and C become defined by the end points of a line segment. When the x and y coordinates of the center 1200 of the root menu are put into six line equations, the results are either positive or negative depending on which side of the lines the center 1200 of the root menu is. When a sampled point of the movement trajectory is not on the same side as the center 1200 of the root menu in respect of all six lines, at least one line equation will result in a number having a different sign with the coordinates of a sampled point. Therefore, it is computationally easy to check whether the signs are different for the latest sampled point of the movement trajectory in comparison to the center 1200 of the root menu. Also, in the rare case where the coordinates of a sampled point fulfill a line equation (thus the sampled point is exactly on the line in terms of precision of a computer numbering format), it is considered as a different sign. If only one equation results in a different sign, the corresponding control element is crossed. This is usually the case with dense computer sampling.

If more than one equation results in a different sign, more than one line should be considered when defining which line segment is crossed first. This situation is solved, for example, in the following way. First, the likely trajectory between the most recently sampled point and the sampled point before that should be approximated. The easiest approximation is to assume that the trajectory is linear between these points and, therefore, it can be defined by a straight line going through these points. This approximation works well in practice. Then, the intersection points of the linear approximation and the crossed lines can be calculated by solving the linear system of two equations for each crossed line. There is one intersection point for each crossed line because of the sign-based pre-selection described earlier. The first crossed line has the most distant (along the movement trajectory) intersection point to the latest sampled point. Even without considering the end points of line segments, the first crossed line also defines the first crossed line segment and, therefore, also the first crossed control element.

Central control elements can be crossed only in one way in the current example, that is, from the center outwards. Therefore, only one item is associated with a central control element, which is a top item in the hierarchical system in the present example of the invention. For this reason, and because no selective action is required after the first crossing, the first crossing in itself provides adequate information for determining the top item to be traversed to. For example in the case of object-oriented programming, the associated top item is held in a member variable of an object wherein the object is an instance of a class representing control elements.

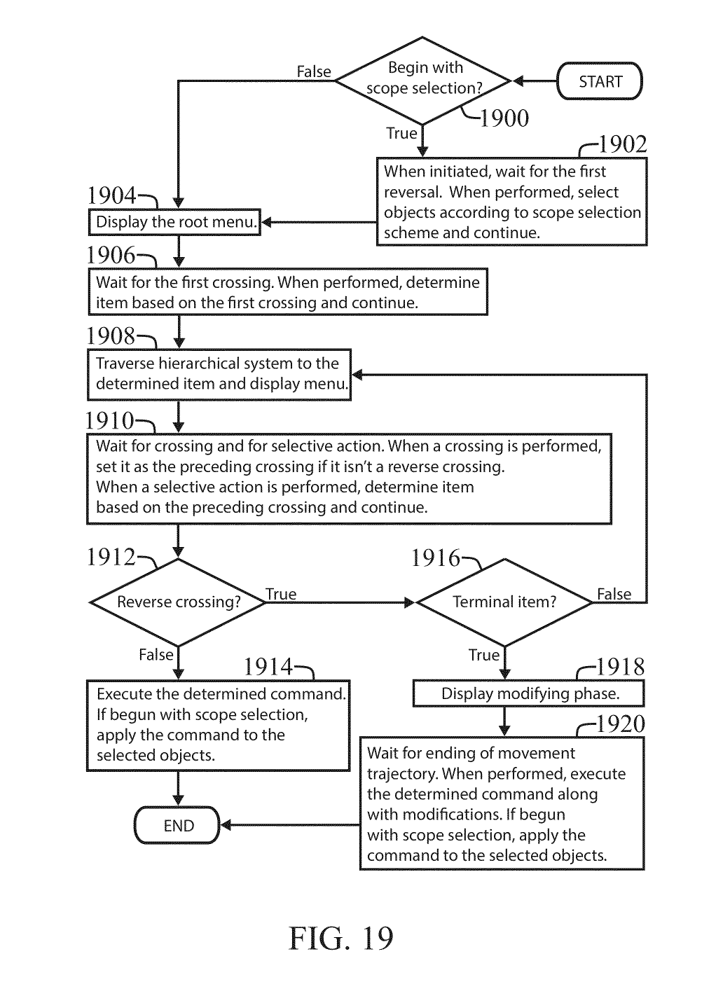

FIG. 19 illustrates a simplified high-level flowchart for scope selection, command phase and modifying phase in accordance with an example of the invention wherein the command phase is illustrated for novice mode. The root menu illustrated in FIG. 12 is displayed at step 1904. That is, after scope selection or, if set to begin without scope selection (for example, with a special switch operated by the non-preferred hand), at the very beginning (for example, when a pointed-at location is detected). When the root menu pops up, it is located so that its center 1200 joins up with the tip point of a reversal (if set to begin with scope selection) or with the beginning of the movement trajectory (if set to begin without scope selection).

FIG. 13A and FIG. 13B illustrate how the selection of the command Edit>Copy is enabled in accordance with an example of the invention. The beginning 1300 of the command phase joins up with the center 1200 of the root menu. At step 1906 (see FIG. 19) the present example of the invention waits for the first crossing while displaying the root menu and the performed movement trajectory. The central control element with which the Edit top item is associated (the Edit top item is visualized in the root menu with the letter E, see FIG. 12) is crossed over by the movement trajectory. As soon as the first crossing 1302 is performed, the present example finds the crossed central control element, determines the top item to be traversed to, and continues from step 1906. At step 1908 the hierarchical system is traversed to the top item and the corresponding menu for the top item is displayed. FIG. 13A illustrates the corresponding menu for the Edit top item, or the Edit menu for short, after the first crossing 1302 is performed.

As it was with the root menu, and will be with other sub-menus, the Edit menu comprises control elements with which are associated part of the hierarchical system. Furthermore, control elements are line segments and they are placed on the edges of hexagons.

Because the Copy command is one of the three most commonly-used commands, it is visualized already in the root menu. This way, even though the visualization changes from displaying the root menu to displaying the Edit menu, an operator has a constant target to be crossed in order to select the Copy command. The same constancy prevails with all three most commonly-used commands in each group. This way the most commonly used commands are the most convenient to select, which will enhance learning and performance.

Other child items, in addition to the three most commonly-used ones, become visualized with the Edit menu. The Edit menu has only three hexagons as a frame for placing control elements because all of the required menu items can be associated in this way. If more menu items are required in a specific implementation of the invention, more hexagons can be added. Note that the hexagon in which the movement trajectory ends up after first crossing 1302 is empty, for the reason described above.

To finish the command phase for the Copy command, the movement trajectory is continued from location 1304 to location 1308 by crossing the control element right next to the Copy command at location 1306. This crossing becomes set as the preceding crossing at step 1910 because the crossing isn't a reverse crossing. Finally, the movement trajectory is ended at location 1308 (which is also the location of the last sampled point). At step 1910 the present example of the invention waits for a selective action. Because a selective action is performed by ending the movement trajectory (which is set as a selective action in the present example) at location 1308, an item in the hierarchical system is determined based on the preceding crossing at step 1910.

After an item is determined, execution continues from step 1910. At conditional step 1912 execution branches off depending on whether the selective action is a reverse crossing or not. If the selective action is reverse crossing, execution leads to traversing in the hierarchy or to a modifying phase (more below). In this case, the selective action isn't a reverse crossing, because it is ending the movement trajectory. Therefore, a terminal item, or a Copy command in this case, becomes determined and the default execution of the Copy command follows at step 1914. If the determined item isn't a terminal item when a selective action is ending the movement trajectory, everything achieved by the current movement trajectory is canceled (relates to browsing, more below). If the movement trajectory has begun with scope selection, the executed command is applied to the selected objects. Scope selection is described in more detail below.

When there is the preceding crossing to a selective action, there is adequate information to determine an item in the hierarchical system in accordance with an example of the invention. More specifically, the crossing specified by the selective action is known, as is the way the control element was crossed and, therefore, an item can be determined Notice that two items in the hierarchical system can be associated with each control element and those two items, in turn, are associated with two different ways of crossing. Further notice that it is possible that there isn't any item associated with the preceding crossing. This situation relates to browsing and is described below.

In accordance with an example of the invention, crossings are sought for at step 1910. If a crossing is found, it is set as the preceding crossing if it isn't a reverse crossing. More specifically, whether a crossing is a reverse crossing to the current preceding crossing is tested at first. If the crossing isn't a reverse crossing, it is set as the preceding crossing (the preceding crossing becomes updated). If the crossing is a reverse crossing, a selective action is found and execution continues from the step 1910.

In the following is described how a crossing can be sought for in accordance with an example of the invention. To begin with, an assumption and the following denotations are made. The trajectory between successive sampled points is assumed to be linear. Then the path of sampled points becomes modeled by a finite sequence of connected straight line segments, denoted by set A:={a₁, a₂, . . . , aₘ} where a₁ is the first line segment in the command phase and m is the number of line segments. Straight line segments corresponding to control elements are denoted by set E:={e₁, e₂, . . . , eₙ} where n is the number of control elements. It is easy to calculate in this setting whether the pair of straight line segments, aᵢ and eⱼ, intersect. This can be calculated, for example, by constructing two straight lines going through the end points of corresponding line segments aᵢ and eⱼ, calculating the intersection point between the lines and, finally, checking whether the intersection point is on both corresponding line segments.

A naïve brute force method is to go through all the line segments in set E in order to find intersections with the line segment aⱼ. In fact, the brute force method is a feasible method when n is relatively small, as it is in the present example of the invention (at most 30). Furthermore, the intersection calculation is computationally very easy. Therefore, if there are not considerably more line segments in set E, there is no practical need for a more efficient method (like the ones suggested in computational geometry).

It is possible, although rare, that end points (which is also sampled points) of aᵢ are on line segment eⱼ in terms of the precision of a computer numbering format. Whether that kind of case is counted as a crossing can depend on the latest end point (in terms of the chronological order of sampled points in the movement trajectory). For example, if the latest end point of aᵢ is not on line segment eⱼ while the other end point is, a crossing is counted, but otherwise not (when the latest end point is on the line segment regardless whether the other end point is on the line segment or not). This way the way of crossing becomes consistently determined (in case, for example, the movement trajectory is ended at the latest end point).

A line segment in set E can be connected by an end point to other line segment in set E. Therefore, it is possible, although rare, that the intersection point (between aᵢ and eⱼ) is equal to the end points of more than one line segment in set E (in terms of precision of a computer numbering format). If more than two line segments are found from set E, only two of them are relevant and the others are irrelevant. More specifically, the relevant line segments are those which can be seen as crossed ones given the location of the latest end point of aᵢ (which is not on relevant or irrelevant line segments because of how crossing are counted, see just above). Therefore, irrelevant line segments can be eliminated, which can be done, for example, as follows. First, vectors from common crossing point to the other end points of line segments and to the latest end point are constructed. Then, angel differences between vectors are calculated. Finally, those line segments are selected as relevant which have smallest angels to positive and to negative rotations in relative to the latest end point. In other words, relevant line segments are neighboring line segments to the latest end point in terms of angels. After relevant line segments are found, or only two line segments were found in the first place, one of those can be determined as crossed one (for example by taking into account other information, such as whether both line segments have an associated item with the particular way of crossing and selecting the one which has).

Let a_{f} and e_{f} be the line segments found in the crossing. The latest end point of a_{f}, which is hereafter referred as p, is not on line segment e_{f} (because of how crossing are counted, see above). Therefore, p is the same as the first sampled point after crossing line segment e_{f} in terms of the chronological order of sampled points in the movement trajectory. In addition, with respect to the visualization, p is on the same side as the item associated with that particular way of crossing. This indicates the way of crossing in order to select an associated item, that is in the present example of the invention, after crossing the movement trajectory comes out on the same side as the visualization of the associated item.

The correct associated item is easy to compute at the point where e_{f} and p are known. It can be computed as follows. Because p is not on line segment e_{f}, fulfilling the corresponding line equation for e_{f} with p results in either a positive or a negative non-zero number. Line equations can be normalized in order to have consistency in the sign of the resulting number. Normalization can be done, for example, by multiplying a line equations by −1 if selected normalization point (which is not on any lines corresponding line segments in set E) doesn't result (by fulfilling the line equation with the normalization point) in a number having the sign as selected. Two different signs of the resulting number reflect which side of e_{f} point p is, or, which way e_{f} is crossed. This results in a two-valued variable by which the associated item can be queried. For example in the case of object-oriented programming, the two items associated with two different ways of crossing are held in member variables of an object wherein the object is an instance of a class representing control elements.

If there isn't an associated item for the query, the following steps can depend on the selective action (which are not illustrated in the simplified high-level flowchart for novice mode in FIG. 19). If the selective action is ending the movement trajectory, everything is canceled. In this way, it is possible to cancel everything achieved by the current movement trajectory. In other words, an operator can cancel everything achieved by the current movement trajectory by ending the movement trajectory after performing a crossing with which there is no associated item. This is a part of the browsing capabilities of the present example of the invention. If the selective action is a reverse crossing, then the likely intention of the operator was to select an associated item but the wrong preceding crossing was unintentionally performed. In this case everything is canceled, the movement trajectory is ended by the present example of the invention, and feedback is given to the operator (for example, the control element preceding the selective action blinks for a short period). In this way, the operator is forced to start from the beginning and guided to perform a more accurate movement trajectory.

If the associated item for the query is not a command and selective action is ending the movement trajectory, everything is canceled (this is not illustrated in the simplified high-level flowchart for novice mode in FIG. 19). In other words, an operator can cancel everything achieved by the current movement trajectory by ending the movement trajectory after performing a crossing with which there is associated other item than a command (such as a non-terminal item). This is a part of the browsing capabilities of the present example of the invention.

If selective action occurs when the preceding crossing hasn't been set, everything is canceled (this is not illustrated in the simplified high-level flowchart for novice mode in FIG. 19). This is a part of the browsing capabilities of the present example of the invention.

The browsing in the present example of the invention differs from the browsing in the traditional user interface paradigm. More specifically, browsing will begin every time from the root menu. That is, if the wrong sub-menu becomes displayed, the only way to correct the mistake is to cancel everything achieved by the current movement trajectory and begin again from the root menu. However, always beginning from the root menu isn't futile because expert mode is implicitly learned, in contrast with the traditional user interface paradigm, and experience with browsing will enable learning. This implicit learning is disturbed at the beginning of learning if an operator is allowed to gradually reverse through the hierarchical system by some means (for example, a button pressed by the non-preferred hand).

As described, it should be tested whether a crossing is a reverse crossing or not, which can be done as follows. If the same line segment of set E (corresponding control elements) is found in the preceding crossing than in the crossing but the sign (calculated with e_{f} and p as described above) is different, a reverse crossing is found.

Notice that if crossing in itself executed a command, there would be adverse consequences as follows. Firstly, in order to cross the intended control element, an operator has to avoid crossing all the other control elements. This, as described above, would require extra inference and steering through tunnels and, in effect, would make selection slower. In addition, a compact arrangement of control elements wouldn't be possible, as described above. Secondly, there can be irreversible consequences when a command is executed by an unintentional crossing, like deleting an important file. Although undo functionality can be implemented, it is inconvenient if the operator has to rely too much on such functionality. Notice that feedback about the crossing event can be provided only after the crossing has already happened. Thirdly, because a command is already executed by a crossing, anything following the crossing would be irrelevant. Therefore, modifying the execution of the command, as described below, wouldn't be possible.

FIG. 14A illustrates how the selection of the command View>Back is enabled in accordance with an example of the invention. With the command, an operator can navigate, for example, back to the previous web page. In FIG. 14A an operator has begun the command phase of the movement trajectory at location 1400 and performed a selective action at location 1406 by ending the movement trajectory. The same steps are traversed with the View>Back command as were traversed with the Edit>Copy command (described above) in terms of the flowchart illustrated in FIG. 19. The first crossing is performed in the root menu (the root menu is illustrated in FIG. 12) at location 1402. After the first crossing is performed, the corresponding menu for the View top item, as illustrated in FIG. 14A, is displayed. The crossing at location 1404 becomes set as the preceding crossing because it isn't a reverse crossing. The item associated with the preceding crossing is the Back command. Finally, default execution of the Back command follows after ending the movement trajectory at location 1406.

In accordance with an example of the invention, whether a modifying phase follows depends on the kind of selective action when a terminal item, or command, becomes determined. If the selective action is ending the movement trajectory, a default execution of the command follows (as illustrated in FIG. 14A). However, if the selective action is a reverse crossing, a modifying phase for the command follows (as illustrated in FIG. 14B). In the modifying phase, the default execution of a command is modified in some way before the modifying phase is ended by ending the movement trajectory.

FIG. 14B illustrates how modifying the default execution of the View>Back command is enabled in accordance with an example of the invention. In this case the modifying phase is such that an operator can specify how many pages he/she wishes to go back. The beginning of the command phase, from location 1400 to the location 1406, is the same as in FIG. 14A. Although not illustrated in FIG. 14B, between these two locations, the View top item is selected with the first crossing in the root menu (the root menu is illustrated in FIG. 12). Consequently, the crossing at location 1404 becomes set as the preceding crossing because it isn't a reverse crossing (the crossed control element is illustrated also in FIG. 14B). The item associated with the preceding crossing is the Back command. However, the selective action is different than in FIG. 14A. In this case the selective action is a reverse crossing at location 1408. Therefore, an otherwise identical flow up to conditional step 1912 will follow a different path because the condition is true. Because a reverse crossing determines a terminal item, or Back command, conditional step 1916 is true and a modifying phase follows. The modifying phase is displayed at step 1918. As illustrated in FIG. 14B, a linear menu is displayed in this case, by which an operator can specify how many pages to go back. At step 1920, the present example of the invention waits for the operator to perform the ending of the movement trajectory. With the ending of the movement trajectory, the operator accepts the current state of modifications. Immediately after the ending is performed, the determined command is executed along with modifications. However, before ending the movement trajectory, the operator can indicate (for example, using a button pressed by the non-preferred hand) if everything achieved by the current movement trajectory should be canceled (this isn't illustrated in the simplified high-level flowchart in FIG. 19). In this way, the operator can cancel an unintentional selection or browse the modifying phase of a command. If the movement trajectory began with scope selection, the executed command is applied to the selected objects. In FIG. 14B the movement trajectory is ended at location 1410 which is within the parameter value of −2 (Two pages away). This means that the Back command is executed with the parameter value of −2, or the browser will go 2 pages back.

When there is little space around the root menu (for example, the root menu is displayed on a small screen or near the screen edges), the most likely available space for performing modifications within the modifying phase is around the middle of the root menu. This means that the previous movement trajectory becomes reversed at some level in order to get to the available space when it is needed to perform modifications for the most commonly-used commands. More specifically, the most commonly-used commands are associated with the outermost control elements and to the outwards crossing. Therefore, the available space is substantially in the other direction with respect to the movement after such a crossing. Therefore, a reverse crossing is a convenient selective action for selecting such commands Furthermore, because the 18 most commonly-used commands can account for most of all command use, this kind of convenience plays a significant role in effectiveness.

Although not necessarily illustrated with little triangles in FIG. 12, many of the most commonly-used commands could have a modifying phase. For example, an operator could specify how many pages to go forward, or how far up. In addition, an operator could specify special parameters for the Paste command (corresponding to the Edit>Paste Special . . . command commonly used in word processor applications), or how many modifications are to be undone. Furthermore, Save and Save As . . . could be merged into one command. The nature of the modifying phase depends on the default execution for a command. For example, by default a command is executed with default parameters (or arguments), or with the most common parameters. Then, in the modifying phase, these parameters could be modified before the command is executed along with the modifications. Another example is that in default execution a command is executed without parameters or, in fact, the command doesn't have parameters. Then, in the modifying phase, parameters could be modified for a parametric version of the command before the command is executed along with the modifications. In this manner, the Paste Special . . . command is a parametric version of the Paste command and the Save As . . . command is a parametric version of the Save command. Notice that merging two related commands into one will enhance learning because there is only one movement trajectory to be learned, instead of two. In addition, notice that if changes in the modifying phase are directly, or instantaneously, applied along with the selected command, ending the modifying phase will make the changes final, rather than executing the command along with modifications.

Notice that the secondary constraint related to selective actions is not present when commands are associated with the outermost control elements and with outwards crossing. This means that, in the present example of the invention, selective action is not needed to be performed within a hexagon and, therefore, the operator doesn't need to regulate amplitude error (which is harder than regulating directional error related to crossing). In addition, because no selective action is required after the first crossing in order to select a top item, the whole command phase can be performed without regulating the amplitude error. In this way the selection of 18 of the most commonly-used commands, which are associated as described above, becomes fast.

FIG. 15A and FIG. 15B illustrate how continuous parameter modification is enabled along with the command View>Zoom in accordance with an example of the invention. The continuous parameter in this case is how much a view is zoomed. For the sake of clarity, this illustration is described without referring to the steps in the flowchart illustrated in FIG. 19. The command phase of the movement trajectory is begun at location 1500 and the first crossing is performed in the root menu (the root menu is illustrated in FIG. 12) at location 1502, by which the View top item becomes determined and the corresponding menu for the View top item, as illustrated in FIG. 15A, becomes displayed. The crossing at location 1504 becomes set as the preceding crossing because it isn't a reverse crossing. The command associated with the preceding crossing represents a slider, a common graphical widget for continuous parameter modification. In such an example, the little magnifying-glass, representing Zoom, within the same hexagon as the slider gives an additional definition to the slider, that is, continuous parameters are modified for the Zoom command. This is an alternative to having one more level in the hierarchy (described in more detail below). FIG. 15A illustrates the beginning of the movement trajectory in the command phase. In FIG. 15B the movement trajectory is continued by performing a reverse crossing at location 1506 (the crossed control element is illustrated also in FIG. 15B), by which the command phase is extended to a modifying phase. As illustrated in FIG. 15B, the modifying phase is displayed as a slider which allows the operator to modify the value with the current location of the movement trajectory. The movement trajectory is ended at location 1508. This means that the Zoom command is executed with the parameter value of 58.79%, or the view is zoomed 58.79%.

As described, the example of the invention enables a very fast way to modify a continuous parameter compared to the traditional user interface paradigm model at its worst, which could include a trip to the main menu, selecting an appropriate menu item from the menu hierarchy, focusing on a variable field in the displayed dialog box and setting the intended value (possible by typing, which would require round trip between the keyboard and the mouse with a hand), pressing the OK button, and making a return trip back to the working location.

Note that in the above described examples of the invention (along with the commands View>Back and View>Zoom) a reversal has no meaning in the modifying phase. Therefore, in order to modify the correct parameter value, the operator can make reversals without, for example, prematurely ending the modifying phase. For example, in the case of FIG. 15B, if the modified parameter value for the Zoom command goes above the intended value, the operator can make a reversal in order to decrease the value and the reversal wouldn't affect the modification in any way.

However, reversals can be used to separate different parameters in some implementations of the invention. For example, in a modifying phase with successive reversals, several parameters can be modified in order of prevalence. More specifically, if the most commonly modified parameters for a pencil tool in a drawing application are color, weight, and brush definition, in that order, the first reversal could be used to set color, the second reversal could be used to set weight, and the third reversal could be used to set brush definition. If the operator doesn't want to modify all the parameters, the movement trajectory can be ended at any stage within successive modifications and the rest of the parameters are not changed (or they are set to default or to the most common values). In accordance with an example of the invention, several parameters can be modified for the selected command and all can be performed with one continuous movement trajectory. This enhances interaction with commonly-modified parameters because round trips to tool boxes, which are commonly near the screen edges, are eliminated.

Furthermore, reversals can be used to separate parameter setting in different precisions in some implementations of the invention. For example, a coarse value can be set for a parameter with the first reversal, after which the parameter can be fine-tuned before ending the movement trajectory. If even more accurate fine-tuning is needed, it can be achieved by making successive reversals before ending the movement trajectory. Notice that this kind of setting is possible even the parameter is two dimensional (for example, two dimensional location).

If a reverse crossing is used to select a command which doesn't have a modifying phase, then the likely intention of the operator was to select a different item, but the operator unintentionally performed the wrong preceding crossing. In this case in accordance with an example of the invention, everything is canceled, the movement trajectory is ended by the present example of the invention, and feedback is given to the operator (for example, the command that was actually selected blinks for a short period). In this way, the operator is forced to start from the beginning and guided to perform a more accurate movement trajectory.

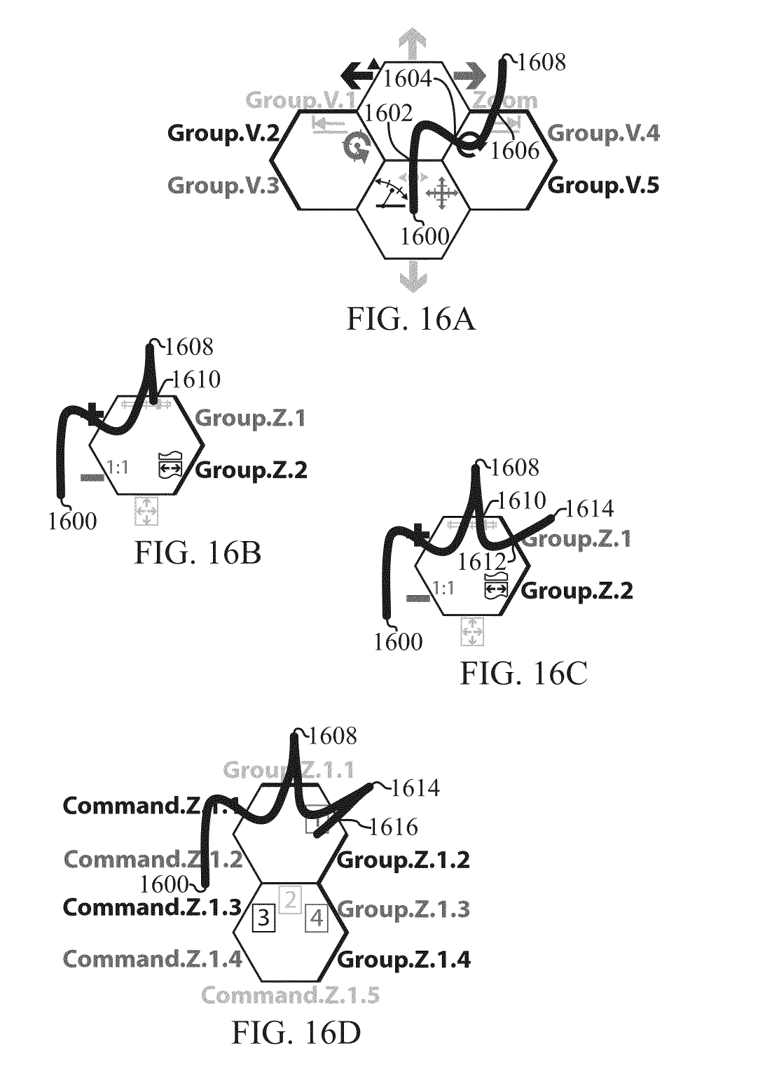

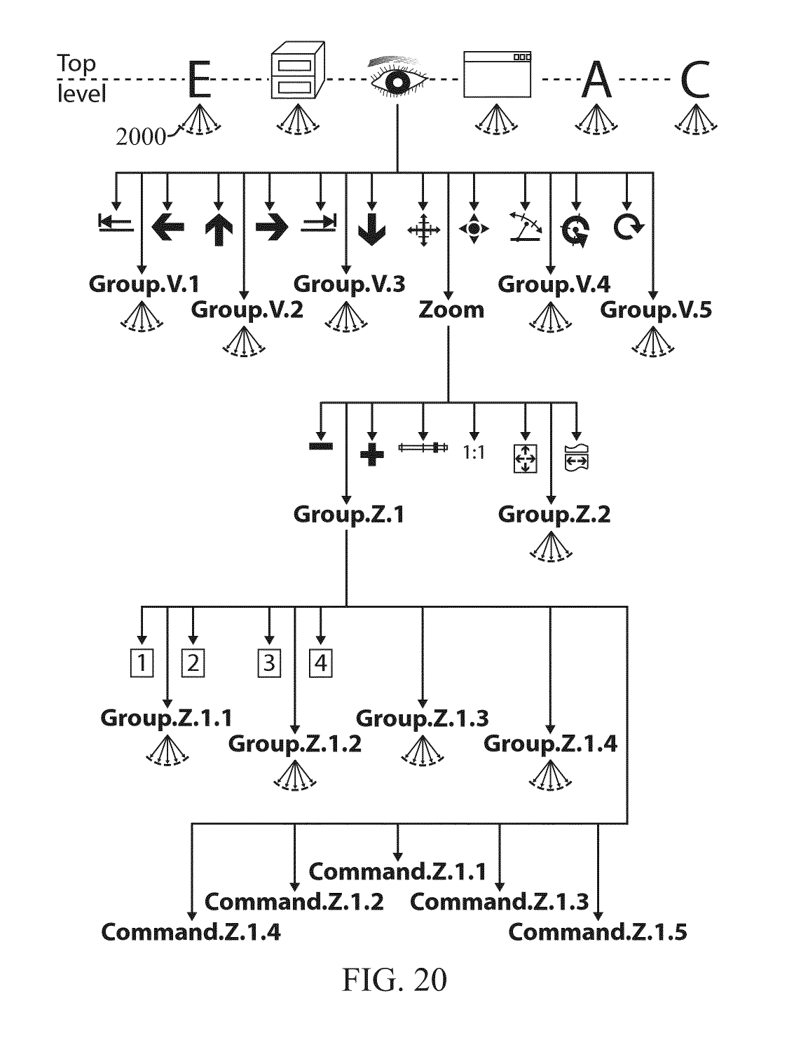

FIG. 16A, FIG. 16B, FIG. 16C, and FIG. 16D illustrate how selection of items in subsequent levels of a hierarchical system is enabled in accordance with an example of the invention. FIG. 20 illustrates the top level of the hierarchical system and, in detail, the part of the hierarchical system represented in FIG. 16A, FIG. 16B, FIG. 16C, and FIG. 16D. Arrows in FIG. 20 point to child items, that is, immediate subordinate items. Parent items, on the other hand, are immediate superior items to child items. If the full name of an exemplary item is represented, the parent item is denoted after the first dot in the full name. For example, Group.Z.1 and Group.Z.2 are two exemplary child items to the Zoom item where the parent item is denoted with the letter “Z” after the first dot. Symbol 2000 under an item represents a part of the hierarchical system which is not illustrated in detail in FIG. 20. If the symbol is not present under an item, then the item is a terminal item. If the symbol is present under an item, then the item is not a terminal item, hereafter referred to as “a non-terminal item”. Terminal items represent commands and non-terminal items represent group of items. The top item is a non-terminal item. A non-terminal item which is also a subordinate item to a top item is hereafter referred as “a subordinate non-terminal item”. In other words, all non-terminal items other than the top items are subordinate non-terminal items. For example, Command.Z.1.1, which is a child item to Group.Z.1 (the parent denoted with the string “Z.1”), is a terminal item, whereas Group.Z.1.1, which is also a child item to Group.Z.1, is a subordinate non-terminal item. The level immediately below the top level is denoted as the second level (containing the Zoom item, for example) and the level immediately below the second level is denoted as the third level (containing the Group.Z.1 item, for example) and so on.

Sub-menus, comprising control elements which are associated with part of the hierarchical system, are designed in such way that, after a reverse crossing, subsequent crossings are as convenient as possible to perform. In addition, control elements in sub-menus align with the control elements in the root menu, that is, a control element in a sub-menu has an equally placed control element in the root menu. Then, an operator has constantly placed targets to be crossed, which increases convenience. Furthermore, the alignment ensures that the movement trajectory does not drift further and further away from the beginning of the command phase (which is also the center of the root menu) with successive levels in the hierarchical system. In other words, sub-menus are as compact as the root menu, if not smaller.

Associations of subordinate non-terminal items follow the following design guideline: subordinate non-terminal items should be associated with outwards crossings and with the closest control elements which, in terms of equal placement, are the outermost control elements in the root menu. However, the associations of the three most commonly-used commands should be maintained (as already visualized in the root menu).

One of the reasons for the design guideline is mentioned above, along with the most likely available space for performing modifications on the most commonly-used commands. More specifically, when associations of subordinate non-terminal items follow the design guideline and a subordinate non-terminal item is about to be selected, the most likely available space is substantially in the other direction in respect to the movement after crossing. Therefore, a reverse crossing is a convenient selective action for selecting subordinate non-terminal items if associations follow the design guideline. In other words, after a reverse crossing by which a subordinate non-terminal item becomes determined, the movement is substantially towards the most likely available space. This becomes apparent along with FIG. 16A, FIG. 16B, FIG. 16C, and FIG. 16D where location 1600 can be thought as the center of the most likely available space.

Notice that subordinate non-terminal items are privileged with the outermost control elements which, in terms of equal placement, are the outermost control elements in the root menu (following the design guideline). Commands are associated with the rest of the control elements. Associations of subordinate non-terminal items can be visually distinguished from terminal (or command) associations, for example, using a thicker line as illustrated FIG. 16A, FIG. 16B, FIG. 16C, and FIG. 16D. Even though a command can be associated with a control element emphasized with a thicker line, this isn't confusing if it is clear that the particular emphasis concerns only an outward crossing.

In FIG. 16A, FIG. 16B, FIG. 16C, and FIG. 16D, after selection of the View top item at the top level, the Zoom item is selected at the second level and the Group.Z.1 item is selected at the third level. The Zoom and Group.Z.1 items are subordinate non-terminal items. The command phase of the movement trajectory is begun at location 1600 and the first crossing is performed in the root menu (the root menu is illustrated in FIG. 12) at location 1602, by which the View top item becomes determined and the corresponding menu for the View top item, or the View menu as illustrated in FIG. 16A, becomes displayed. After the first crossing, the movement trajectory is continued to location 1608. In terms of the flowchart illustrated in FIG. 19, since the beginning of the command phase, step 1904, step 1906, and step 1908 are traversed by ending at step 1910. The crossing at location 1604 becomes set as the preceding crossing at step 1910 because it isn't a reverse crossing. Subsequently, the crossing at location 1606 becomes set as the preceding crossing at step 1910 because it isn't a reverse crossing. After setting the preceding crossing second time, the item associated with the preceding crossing is Zoom.

Notice that there are no subordinate items to the Zoom item in the View menu. In order to select a subordinate item to the Zoom item, the Zoom item should be selected first. This is an alternative to the example of the invention in which additional hierarchy was avoided (as indicated along with FIG. 15A and FIG. 15B).

As can been seen with the movement trajectory illustrated in FIG. 16B, a reverse crossing (the first selective action) was performed at location 1610 in the View menu (the View menu is illustrated in FIG. 16A). In other words, the same control element was crossed back over in the opposite direction before crossing other control elements. Therefore, the item associated with the preceding crossing, that is the Zoom item, became determined at step 1910 and execution continued from step 1910. Conditional step 1912 was true because the selective action was a reverse crossing. Conditional step 1916 was false because the Zoom item wasn't a terminal item. Therefore, the hierarchical system was traversed to the determined item, that is the Zoom item, and the corresponding menu for the Zoom item, or the Zoom menu, was displayed at step 1908. After displaying the Zoom menu, as illustrated in FIG. 16B, the preceding crossing is updated with the Zoom menu at step 1910. More specifically, in addition to the reverse crossing made in the View menu, a crossing is made in the Zoom menu because the both menus have equally placed control elements. Because the crossing in the Zoom menu isn't a reverse crossing, it becomes set as the preceding crossing. The command associated with the preceding crossing represents a slider in this case. Notice that between the first crossing at location 1602 and the crossing at location 1606 was performed the crossing at location 1604 but this crossing has no effect, and it does not prevent the selection of the Zoom item.

As illustrated in FIG. 16C, the movement trajectory is continued to location 1614. The crossing at location 1612 becomes set as the preceding crossing at step 1910 because it isn't a reverse crossing. The item associated with the preceding crossing is Group.Z.1.

As can been seen with the movement trajectory illustrated in FIG. 16D, a reverse crossing (the second selective action) was performed at location 1616 in the Zoom menu (the Zoom menu is illustrated in FIG. 16B and in FIG. 16C). Therefore, the item associated with the preceding crossing, that is the Group.Z.1 item, became determined at step 1910 and execution continued from step 1910. Conditional step 1912 was true because the selective action is a reverse crossing. Conditional step 1916 was false because the Group.Z.1 item wasn't a terminal item. Therefore, the hierarchical system was traversed to the determined item, that is the Group.Z.1 item, and the corresponding menu for the Group.Z.1 item, or the Group.Z.1 menu, was displayed at step 1908. After displaying the Group.Z.1 menu, as illustrated in FIG. 16D, the preceding crossing is updated with the Group.Z.1 menu at step 1910.

As illustrated in FIG. 16D, the Group.Z.1 menu can be used to select one of the four non-terminal items or one of the nine commands (five commands are visualized with full names and four with icons). The selection of these can be performed as described above.

Notice that if the movement trajectory is ended at location 1608 or at location 1614, everything achieved by the current movement trajectory is canceled as described above along with the browsing capabilities of the present example of the invention

Whether or not more levels are added to the hierarchical system depends on the particular implementation of the invention. If a group has more than a couple of items, it might be advantageous for all items to have a common beginning up to the group selection level. This most likely enhances expert mode learning because there is a common beginning deeper to the hierarchical system. However, studies on human-computer interaction suggest that breadth should be preferred over depth. Therefore, with few items, additional levels should be avoided.

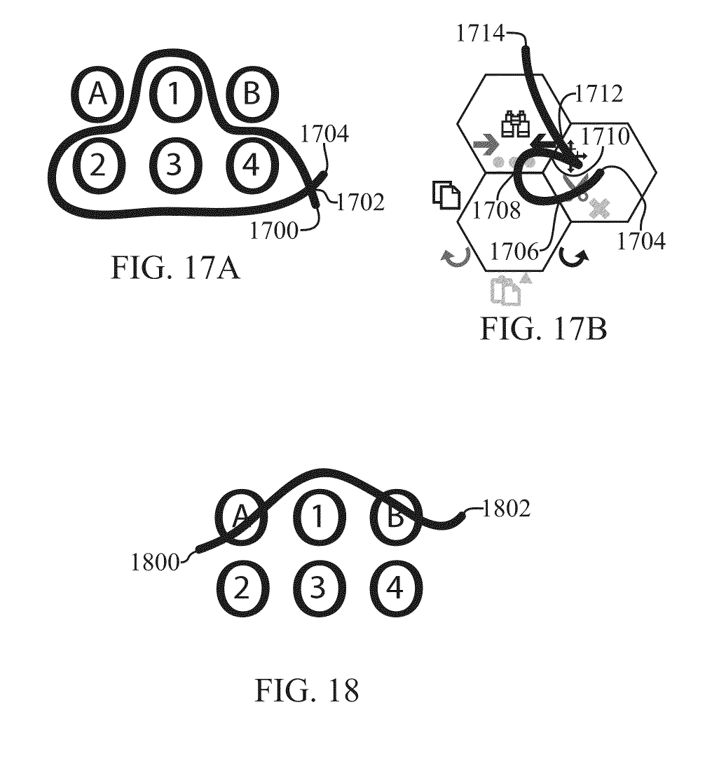

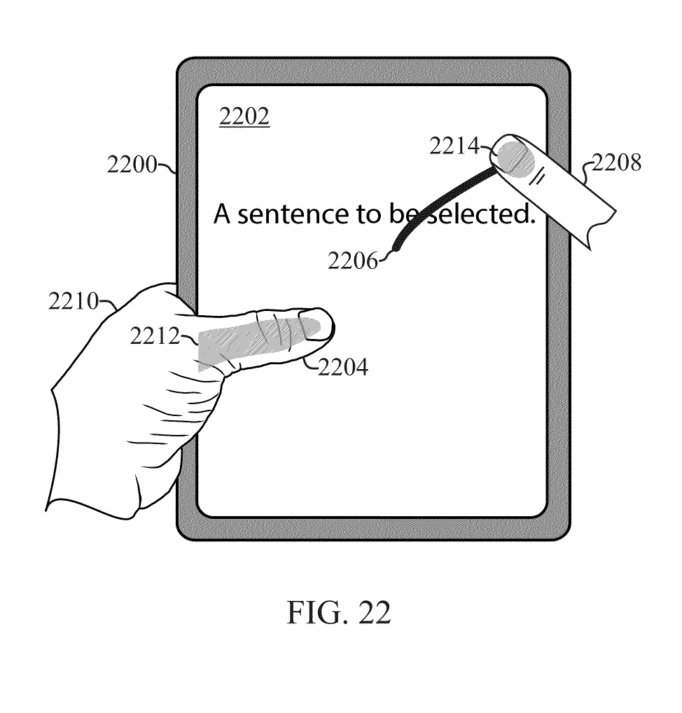

FIG. 17A and FIG. 17B illustrate how scope selection, command selection and the modifying phase are enabled in accordance with an example of the invention. FIG. 17A and FIG. 17B illustrate the case where selected objects are moved using the Edit>Move command to the location specified in the modifying phase. All this—scope selection, command selection and the modifying phase—can be performed with one continuous movement trajectory. An operator can indicate if the movement trajectory begins with scope selection. Such indication can be, for example, pressing a button with the non-preferred hand. Along with FIG. 22 is described another example for such indication. Then, conditional step 1900 would be true. This leads to step 1902 where intended objects are selected according to the scope selection scheme.

In FIG. 17A the intended objects, or the objects which the operator wants to be selected, are the ones labeled with numbers. The scope selection scheme in FIG. 17A is the following: first, the intended objects are enclosed using a self-intersecting movement trajectory and, then, a posterior reversal ends scope selection and begins the command phase. Therefore, reversal recognition is initiated after the self-intersection. When the first reversal is found, objects are selected according to the scope selection scheme and execution continues from step 1902. In FIG. 17A the movement trajectory begins at location 1700 and makes a self-intersection at location 1702. Beginning at location 1704, a substantial length of the movement trajectory becomes substantially reversed, as illustrated in FIG. 17B. In other words, the movement trajectory in FIG. 17A is continued in FIG. 17B so that the tip point of the first reversal (at location 1704) is common between these two. Note that the movement trajectory is continuous even though it is illustrated in two different figures.

FIG. 17A illustrates scope selection and FIG. 17B illustrates command selection as well as the modifying phase. At step 1904 the root menu (as illustrated in FIG. 12) is displayed so that the center aligns with the tip point of the first reversal (at location 1704). The command phase of the movement trajectory begins at the tip point. Because the command phase is already described by referring to the steps in the flowchart illustrated in FIG. 19, such referring is omitted below. The first crossing is performed in the root menu (the root menu is illustrated in FIG. 12) at location 1706, by which the Edit top item becomes determined and the corresponding menu for the Edit top item becomes displayed as illustrated in FIG. 17B. The crossing at location 1708 becomes set as the preceding crossing because it isn't a reverse crossing. Subsequently, the crossing at location 1710 becomes set as the preceding crossing because it isn't a reverse crossing. After setting the preceding crossing second time, the item associated with the preceding crossing is Move. A reverse crossing is performed at location 1712. Therefore, the item associated with the preceding crossing, that is the Move item (represented by the icon with four arrows pointing in different directions), becomes determined. Notice that between the first crossing at location 1706 and the crossing at location 1710 was performed the crossing at location 1708 but this crossing has no effect and does not prevent the selection of the Move item.

Because the selective action is a reverse crossing and the Move item is a terminal item, a modifying phase follows in the present example of the invention. In the modifying phase the two dimensional location to which the selected objects are to be moved is specified by using the current location of the movement trajectory. When the movement trajectory is ended at location 1714, the Move command is executed along with the specified location. Or, selected objects are moved to the specified location. Notice that in the present example, a reversal doesn't have any meaning in the modifying phase. However, in some implementations of the invention, it might be advantageous to modify several commonly-changed parameters for the Move command with successive reversals in the modifying phase. For example, the first reversal could be used to set location, the second reversal could be used to set rotation, and the third reversal could be used to set tilt.

The reason why reversals are not recognized before the self-intersection point in the above described scope selection scheme is that this allows an operator to more freely enclose the intended objects, even using a movement trajectory containing reversals (if it is convenient). In addition, a self-intersecting movement trajectory unambiguously defines the intended objects. This wouldn't be the case with a partial enclosing, that is, with a movement trajectory which does not self-intersect. Then some kind of heuristic should be applied in order to define which objects are enclosed and which are not. However, a reversal can also be used to change to the command phase when no self-intersection is required. Then the first reversal will lead to a command phase and reversal recognition is initiated at the beginning of the movement trajectory. In that case, no reversals should be performed before scope selection is accomplished as intended.

The above described self-intersection can be monitored as follows. The trajectory between successive sampled points is assumed to be linear. The path of the sampled points becomes modeled by a finite sequence of connected straight line segments. The computational problem is then whether the latest line segment crosses any of the previous ones when considering the chronological order of sampled points in a movement trajectory. If computation is done against every previous line segment with every latest line segment, the overall running time is O(n²) where n is the number of line segments. With dense sampling and long movement trajectories, a less complicated running time is required. One possibility is to model several sampled points with one line segment, when a finite sequence of connected line segments has fewer items. This would require more complicated algorithms for determining such line segments. Another possibility is to use the methods suggested in computational geometry. After all, the line segment intersection problem is one of the most fundamental problems in computational geometry and, therefore, studied widely. For example, methods based on overlapping orthogonal projections of candidate line segments can have a running time of less than O(n²).

A self-intersecting path becomes modeled by a closed polygonal chain (when excluding the parts beyond self-intersection), or a polygon. The boundaries of an object can be modeled using a polygon. In this setting, enclosing is a matter of Boolean operations on polygons, a common problem in computational geometry. Computational geometry also supplies efficient methods for solving the problem. Which objects are defined as enclosed can depend on the implementation of the invention and user preferences. For example, the definition can based on whether an object is fully or substantially enclosed in terms of the bounding polygon of the object or what is visual to the operator about the object. Alternatively, only the central point of the object needs to be enclosed.

FIG. 18 illustrates how scope selection is enabled, in accordance with an example of the invention, when scope selection is based on crossing the intended objects. In FIG. 18 the intended objects, or the objects the operator wants to be selected, are the ones labeled alphabetically. In this case, enclosing the intended objects would be slower compared to crossing them (as illustrated in FIG. 18) because enclosing would require a much longer movement trajectory and steering through tunnels between objects. The longer and the narrower the tunnels between objects are, the slower the execution is, as described in Steering law. In addition, with strongly elongated objects, selection based on crossings is more efficient compared to enclosing the intended objects. This is the case, for example, with the long links in a Web browser and sentences in a word processing application.

The scope selection scheme in FIG. 18 is the following: first, the intended objects are crossed with the movement trajectory and, then, a posterior reversal ends scope selection and begins the command phase. Therefore, reversal recognition is initiated at the beginning of the movement trajectory and crossed objects become selected by the first founded reversal. The movement trajectory begins at location 1800 in FIG. 18. Beginning at location 1802, a substantial length of the movement trajectory becomes substantially reversed. Reversal is not illustrated in FIG. 18 but it could be performed as illustrated in FIG. 17B. In other words, the movement trajectory in FIG. 18 is continued in FIG. 17B so that the tip point of the first reversal (at location 1802 in FIG. 18 and at location 1704 in FIG. 17B) is common between these two. Note that the movement trajectory is continuous even though it is illustrated in two different figures. The following command selection and modifying phase can be performed as described above along with FIG. 17B. Therefore, scope selection, command selection, and a modifying phase can be performed with one continuous movement trajectory, even if scope selection is based on crossings.

Which objects are defined as crossed can depend on the implementation of the invention and user preferences. For example, one definition may be based on whether crossing is required to begin and end outside of an object in terms of the bounding polygon of the object or what is visible to the operator about the object. When the path of sampled points is modeled by a finite sequence of connected straight line segments, the computational problem is to search for the bounding polygons (representing objects) that the sequence crosses. This can be solved, for example, by going through all the edges in bounding polygons in order to determine if they intersect one of the line segments in the sequence. Alternatively, overlapping orthogonal projections can be used to reduce running time.

Although in the above described example of the invention scope selection is first, followed by command selection and a modifying phase, the order of these three phases can be different in accordance with an example of the invention. Notice, however, that some orders are impossible, such as a modifying phase preceding command selection, or inconvenient, such as scope selection between command selection and a modifying phase.

Performing scope selection and command selection with one continuous movement trajectory will make interaction more efficient, especially when discontinuity is slow and tedious to articulate. Furthermore, if multiple operators are using the same user interface at the same time, the traditional user interface paradigm is confusing. More specifically, it may be unclear which operator is using which menu and to which selected object (or objects) a command (selected by a menu) should be applied. When scope selection and command selection, and a modifying phase if needed, is performed with one continuous movement trajectory as described above in accordance with an example of the invention, multiple concurrent operators at the same user interface are not confused in this way. This enables, for example, non-confusing user interfaces for collaborative brainstorming, traffic controlling or computer-aided design and engineering.

However, in some implementations of the invention it might be advantageous to perform scope selection and command selection in a discontinuous manner, or in separate phases. Also in this case, command selection can be performed as described above in accordance with an example of the invention. In the traditional user interface paradigm, the intended objects are commonly selected using a rectangular selection region specified by a drag operation or by tapping on the objects while holding down a modifier key (like Ctrl). After the intended commands are selected (by whatever means), a command phase begins when, for example, the movement trajectory begins over the selected objects. That is, in the case of stylus-based interaction on a touch screen, when the stylus comes into contact with the touch screen at a location which is on the selected objects. Alternatively, the operator indicates when the command phase should begin by pressing a button with his/her non-preferred hand, possibly in conjunction with the beginning of a movement trajectory.

A pop-up menu can be context-sensitive in accordance with an example of the invention. For example, the selections available in the pop-up menu depend on selected objects or on another context.

The root menu in accordance with an example of the invention, as illustrated in FIG. 12, occupies all possible directions in respect of the pointed-at location when the menu pops up. This means that extra measures are needed when the root menu is activated very close to the edges of a screen, that is, when there isn't enough space for selecting all possible commands. Because an example of the invention provides a very compact design, the proximity of screen edges isn't so much of a problem as it is with prior art designs, such as linear menus.

When there is an excess of screen real estate (for example on computer displays and wall-mounted displays), the working area is commonly surrounded with various bars (title bar, scrollbar, status bar, and so on) and margins so that, even if the root menu pops up in the corner of the working area, there can be still be enough space for selecting commands. At the other extreme are small screens on which the working area should occupy as much screen real estate as possible. However, the smaller the screen is, the more irrelevant round trip elimination becomes. Therefore, without reducing performance too much, the root menu can be fixed to the center of the screen, which eliminates the problems caused by screen edges. Here, it is assumed that the root menu fits within the screen area, which, compared to other designs, is achieved more easily with an example of the invention, thanks to its compactness.

Nevertheless, below are examples of how selections can be enabled if selections are otherwise unavailable. An example is to pop up the root menu in the nearest location at which all the commands can be conveniently selected. Then the center of the root menu is in a substantially different location from the pointed-at location when the root menu pops up. In this case, an operator is required to relocate the pointed-at location into the central hexagon in order to begin the command phase (the command phase begins as soon as the pointed-at location is found within the central hexagon). In another example, the center of the root menu joins up with the pointed-at location when the root menu is initiated. In this case, if it is not possible to perform all of the intended crossings, the operator can re-center the root menu by performing a reversal beyond the “re-centering ring” surrounding the root menu. The re-centering ring is so large that crossings over the outermost control elements can still be conveniently specified by reversals within the re-centering ring, in case an intended command is available for selection without re-centering. However, reversals beyond the re-centering ring are interpreted as re-centering commands and the root menu is relocated so that the center of the root menu joins up with the tip point of such a reversal.

Therefore, the meaning of the reversal depends on whether the reversal is performed within the re-centering ring or not. The re-centering ring is visualized if some commands are unavailable.

As described along with FIG. 11, the movement trajectory itself becomes implicitly learned by performing selections enough times in novice mode. An operator can reproduce such movement trajectories, hereafter referred to as “expert trajectories”, quickly and without visualization.

Implicit learning happens in the command phase in accordance with an example of the invention. For example, after selecting the Edit>Copy command, as illustrated in FIG. 13A and FIG. 13B, often enough, the operator implicitly learns the expert trajectory for the command. With such an expert trajectory, the operator can select the Edit>Copy command in expert mode in accordance with an example of the invention. All reproduced expert trajectories corresponding to the Edit>Copy command have the same essential features as the movement trajectory from location 1300 to location 1308. In other words, when a particular selection in the command phase is considered, the trajectories in novice mode are similar to the trajectories in expert mode. Otherwise, implicit learning wouldn't be possible.

Expert trajectories can be performed quickly in expert mode because, for example, there are no spatial constraints to be crossed correctly. This is in contrast to novice mode, in which control elements set spatial constraints.

Notice that expert trajectories become defined by control elements and associations in novice mode. Therefore, a user interface designer implementing an example of the invention doesn't have to figure out expert trajectories because they are already defined in novice mode. This would make implementation easier for the designer.

When the command phase in accordance with an example of the invention is considered, important characteristics for a good expert mode are that the operator should be able to learn expert trajectories for as many selections as possible and a recognizing component should be able to distinguish between different expert trajectories (corresponding to different selections). There are a variety of supervised machine learning algorithms by which recognizing component can be implemented, such as artificial neural networks (for example, Recurrent neural network which can have bidirectional Long Short-Term Memory architecture). Supervised algorithms can be used because successful selections (ones which are not canceled by the operator) in novice mode provide labeled training data for the recognizing component (different labels correspond different selections, which are known in novice mode). Also, the most likely selection can be determined based on models which enable reasoning under uncertainty, such as Bayesian networks.

Notice that expert trajectories can be categorized based on the number of reversals found in an expert trajectory (reversal recognition, as described above, can be done for expert trajectories as well). More specifically, because a reverse crossing is convenient to perform with a reversal in novice mode, a reversal found in an expert trajectory most likely corresponds a reverse crossing (by which the hierarchical system is traversed or command phase is extended to modifying phase). Therefore, expert trajectories can be categorized based on how many reversals they have and recognition can be done within a category, for example. This way the number of the features extracted can grow along with the number of reversals. Notice that the location and the orientation of reversals are important features in recognizing expert trajectories.

In accordance with an example of the invention, reversal recognition can be used for extracting features from movement trajectories. For example, when letters “m” and “i” are written with cursive letters, or epsilon or the number “3” are written (see FIG. 1A), they should have the right number reversal in the right orientation, or otherwise the meaning might not be as intended (for example, if “m” is written only with one reversal, it is “n”). Therefore, the number and the orientation of reversals can be an important feature for recognition, such as for handwriting recognition.

Human psychology research strongly suggests that characteristic to our learning is that we combine atomic concepts to form new chunks of information (for example, phonemes chunked into words). This suggests that an operator could chunk related commands, at least when there is clear classification. Then, the top items could represent chunks of commands. Short-term memory can hold about 4-7 chunks, almost regardless of the information content of the chunks. Therefore, it should be possible for an operator to hold all the six top items (as illustrated in FIG. 12 and FIG. 20), or six chunks, in his/her short-term memory. For example, with an unknown command which doesn't clearly belong to any category, an operator might go through all the top items in his/her short-term memory in order to find the best matching one. On the other hand, if the classification is clear, the operator might make an instant association with the correct top item and act accordingly. Selecting one of the top items would reduce the number of possible items markedly (to about one-sixth) which would reduce the visual search time compared to a situation in which the operator has to search through all of the items visually. Notice that, in the worst case, the visual search time is a linear function of the number of items. Therefore, it is better to minimize the number of items which must be searched visually, and reducing to one-sixth is better than reducing to one-fourth, for example. In this respect, all the items belonging clearly to one sub-class, like the Zoom commands as described above, should have a common beginning in the movement trajectories. Then the operator will more easily learn the expert trajectory which corresponds to the common beginning, and visual searching is reduced to the items belonging to the sub-class after the common beginning is selected in expert mode (which can be followed by novice mode, see below).

If we are not expert enough to decide instantly which way to go at a junction, we pause for a while in order to consider the possibilities. Hence, a long enough pause in execution would be a good trigger for providing assistance to the operator. An example of the invention can be switched from expert mode to novice mode within same trajectory if the operator pauses for a predetermined time, or possibly if performance is too slow. Therefore, the operator can quickly make the expert trajectories that he/she has learned and pause to consider the rest of the trajectory. A pause indicates that the operator is at the limit of his/her expertise and novice mode is visualized at the state which corresponds to the selections performed so far. From there, the operator can easily finish the trajectory. The operator eventually learns to perform the whole selection in expert mode by finishing the trajectory enough times with the help of novice mode. In this way, further expertise can be built on prior expertise. The duration of the pause can be predetermined, for example, by monitoring test users. Also, the operator can adjust the duration of pause at will.

An example of the invention provides seamless transition from novice mode to expert mode because of implicit learning, and back to novice mode within the same trajectory if needed. The more expert trajectories an operator learns, the better, but an example of the invention can be used without learning any, or by learning only a few expert trajectories. However, it is reasonable to expect that an operator can easily learn expert trajectories for the 18 most commonly-used commands, and already with that level of learning, an example of the invention can commonly be operated in expert mode (and can account more than 80% of all command use as described above).

There are numerous different ways of performing pointing in accordance with an example of the invention. Pointing can be direct or indirect. A mouse is an indirect pointing device because an operator should move the mouse to indicate a pointed-at location (indicated by a cursor, for example), whereas a direct pointing device has a unified input and display surface. For example, touch screens are direct pointing devices. Pointing devices can sense different properties. Most pointing devices sense linear position, motion, displacement, or force. Pointing devices can also sense angle, change in angle, and torque. For example, touch screens sense the position of a finger, or a stylus, mice sense motion (changes in position), and isometric joysticks sense force. Position-sensing devices are called absolute input devices, whereas motion-sensing devices are called relative input devices. A transfer function maps the sensed property to the pointed-at location. For example, a transfer function can be a force-to-velocity function (with isometric joysticks, such as IBM TrackPoint), a position-to-position function (with touch screens), or a velocity-to-velocity (with mice) function. The input recognition system of a computing device can be configured to provide a pointed-at location (which can be used for constructing the movement trajectory in accordance with an example of the invention), whether a pointing device is direct or indirect, relative or absolute, whatever the transfer function, whatever the sensed property, whatever the method of pointing, and so on.

In addition, an example of the invention can be used with gaze pointing techniques or with eye tracking technologies. For example, eye tracking technologies can be used for rapid relocating of the pointed-at location, at which scope selection and/or command selection (along with modifying phase) can be performed as described in accordance with an example of the invention.

The pointed-at location can be represented by a point, or a zero-dimensional object represented by coordinates, in input space in accordance with an example of the invention. This is possible even when pointing is performed by finger on a touch screen where touch sensors sense a contacting area, rather than a contacting point. However, the contacting area can be reduced to a representative point in various ways. For example, the contacting area can be thought of as a uniformly distributed mass in which a representative point, or pointed-at location, can be calculated as the center of the mass is calculated. Alternatively, imaginary mass can be distributed to the contacting area as a function of contact, such as sensed pressure or capacitance on touch screens. Similar techniques are possible with other dull pointing objects in other environments, like a hand in three-dimensional pointing.

An operator can perform pointing with all ten fingers in accordance with an example of the invention. Such pointing can be sensed, for example, with touch-sensitive surfaces. In addition, different root menus, or different sub-menus, can be associated with different fingers in accordance with an example of the invention. In such an example, the particular finger performing pointing can be determined by modeling the operator's hands and fingers based on prior knowledge on human anatomy and data from sensors, for example. The sensors can include variety of proximity sensors (for example, infrared, acoustic, and capacitive proximity sensors) and/or cameras, data of which can be combined by means of sensor fusion. Note that with ten fingers can be operated ten different root menus, or sub-menus, by which the number of efficient selections becomes multiplied (because, for example, traversing in hierarchical system is reduced or switching between different menus is eliminated). In addition, selection of different items can be performed concurrently, or almost concurrently, if the items are in different menus. Alternatively, or in addition, to the association with different fingers, different menus can be associated with different origin of pointing (relative to a frame of reference) in accordance with an example of the invention.

In accordance with an example of the invention, an operator can select the intended menu with finger and perform the movement trajectory with a stylus (or with other pointing device).

There are various ways to provide feedback to an operator in accordance with an example of the invention. For example, visual, tactile, and audio feedback can be provided.

Examples of visual feedback are described above, but other kinds of visual feedback can also be provided in accordance with an example of the invention. For example, the current location in the hierarchical system and the selected items so far can be visualized, such as View>Zoom>Group.Z.1, where the last item is the current location (and can be emphasized). This feedback can be provided in both novice and expert modes. In this way, the operator is more confident in executing the particular command. This feedback can be extended to the modifying phase as well, such as View>Zoom: 68.79% or View>Back: −4. Notice that visual feedback can be provided in a way that is convenient to the operator. For example, convenience can be increased on touch screens by providing auxiliary visualization (of a root menu or of a sub-menu along with a movement trajectory) in the part of touch screen which is not obstructed by the finger (or by the hand). Such an auxiliary visualization can be zoomed at a level which is convenient to the operator without, however, affecting the effectiveness of the interaction. When a touch-sensitive surface (a touchpad, for example) is used for inputting, visual feedback can be provided in a display. In addition, touch-sensitive surface can be on different side of a device in relation to display, enabling touch input without obstructing visual feedback. Devices like head-up displays or head-mounted displays can be used to provide convenient visualization in some implementation of the invention.

Tactile and audio feedback can be used in various ways in accordance with an example of the invention. For example, tactile and/or audio feedback can be provided when a control element is crossed, a reverse crossing is performed, and the movement trajectory is ended. When the touch screen is operated by a finger, feedback about the event of crossing over a control element is especially convenient because the finger obstructs most of the control element. Furthermore, different forms of feedback can be provided in different situations. In addition, the operator can be informed of the existence and the location of control elements using tactile feedback. Tactile and audio feedbacks are important in operating an example of the invention without looking at the visualization, or eyes-free. For example, in eyes-free operation, and with the help of tactile and/or audio feedback, the operator can be informed about crossings, selected items, the types of selected items, the modifying phase, and so on. Eyes-free operation is important when the operator is, for example, driving a vehicle or piloting an aircraft at the same time. Eyes-free operation is convenient to perform with a device attached, or integrated, to a steering wheel, to a control stick, or to another place which can be easily reached by the operator. In these cases, head-up displays, like the ones in a windshield, would be a safe way to provide visual feedback.

An example of the invention remarkably increases the efficiency of interaction with professional applications, such as drawing applications and computer-aided design and engineering applications. These applications are commonly very command intensive, professionals use them a lot during a work day, and they have a lot of commands. Because they have a lot of commands, keyboard shortcuts are practical only for a very small fraction of commands. Mapping lots of commands to the keyboard is impractical, as it quickly becomes confusing and difficult to remember. Commonly, an operator remembers just a few keyboard shortcuts, and not many in addition to Ctrl-C, Ctrl-X, Ctrl-V, Ctrl-A, and Ctrl-S (if even these). Therefore, the operator makes a lot of round trips to menus and toolbars located near the screen edges in the traditional user interface paradigm. An example of the invention increases the efficiency of interaction because round trips are eliminated. Furthermore, an example of the invention increases efficiency because of the implicitly learned expert mode, which can be switched to novice mode within the same trajectory if needed. Furthermore, an example of the invention provides efficient scope selection and an efficient modifying phase.

Professional applications requiring precise motor skills, such as drawing skills, are commonly operated by pen. Commonly, the position of the pen is recognized with electromagnetic positioning technology which uses coils embedded in the pen and under a display, or under a graphics tablet. Generally, larger displays enhance overall productivity because, for example, the operator is able to see and access more information at one time. However, the larger the display is, the longer the round trip will be, and also the slower pen-based operation will be in the traditional user interface paradigm. Notice that in order to tap within a control near the screen edges, where menus and toolbars are commonly located in the traditional user interface paradigm, the pen first has to be moved to near the screen edges and over the control. Because an example of the invention eliminates round trips, it doesn't have this disadvantage. Therefore, such an example remarkably increases efficiency in pen-based operation with large displays.

An example of the invention remarkably increases the efficiency of interaction with electronic paper technologies, or technologies employing electrophoresis and charged particles with a distinguishable color. Electronic paper technologies are commonly used in e-book devices (devices used for reading electronic books). In electronic paper technologies with an electric field, which causes the electrophoresis, can be controlled whether the color of charged particles is visible or not. These technologies have low power usage because power is only drawn when the display is updated. However, because of electrophoresis, these technologies have a very low refresh rate compared to other display technologies, such as LCD. In addition, a shadow of the previous image may be visible after updating parts of the display, which is why several devices with electronic paper technologies update the entire screen with constant color before updating to a new image. Because of these disadvantages, electronic paper technologies are slow for implementing interactive menus, such as the ones in the traditional user interface paradigm. An example of the invention increases the efficiency of interaction with electronic paper technologies because, after learning, such an example can be operated in expert mode most of the time. More specifically, an operator can operate in expert mode without visualization and, therefore, slow display updates don't prevent efficient interaction. In addition, power usage is reduced because it is not necessary to update the display so often. Furthermore, an auxiliary display with a high refresh rate (for example, LCD) can be employed for visualizing the selected items so far and for visualizing the modifying phase (such as View>Zoom: 68.79%). Then the operator is more confident in executing the particular command in expert mode without updating the slow display at all, while novice mode can be visualized on the slow display if needed.

As described above, an example of the invention has compact, efficient, browsable, and self-revealing command selection along with wide breadth and an implicitly learned expert mode. Therefore, such an example enables efficient selection of lots of commands even if there are tight space requirements on input, as is the case on devices with small, or rather small, touch screens, such as mobile phones and tablets.

An example of the invention increases the efficiency of interaction with cameras which can have lots of commands, or parameters to modify. Professional cameras (such as still and video cameras), in particular, provide lots of different functions and are covered with buttons. A problem with buttons is that they are subject to mechanical failure, especially in difficult environments containing dust and humidity. In addition, a device containing buttons is difficult to keep clean, whereas a smooth surface is easy to keep clean. For example, cleanliness is essential for medical devices in order to stop infections from spreading. Therefore, at least in the above mentioned cases, controlling a device by a touch-sensitive surface (such as a touchpad or touch screen) would be preferable to controlling by buttons. With touch-sensitive surfaces, an example of the invention has the benefits described above, such as compactness. Therefore, the fairly small camera chassis can contain, for example, a touch-sensitive surface by witch controlling can be performed as described in accordance with an example of the invention. In addition, compactness can be improved a little bit if tapping within an area surrounded by control elements is utilized (for example, for executing a command which adds a character).

Controlling can also be remote in accordance with an example of the invention. Remote controlling can be connected to a controlled device or to an apparatus via a communication link. The controlled device or the apparatus can be anything, such as a computing device, a vehicle, a boat, or an aircraft, where computing is performed by the controlled device or apparatus (with embedded computing capabilities) or by an auxiliary computing device.

When three-dimensional interaction is considered in accordance with an example of the invention, the control elements are surfaces and crossing is passing through a surface with a three-dimensional movement trajectory. With these exceptions, similar things can be accomplished with three-dimensional interaction as with the two-dimensional interaction, as described above in accordance with an example of the invention. In three-dimensional interaction, an operator points at a location in space. For example, an operator points at a location with his/her hand in the space surrounding the hand and pointing is sensed by cameras, or devices employing light-sensing pixels. An input recognition system can calculate the pointed-at location in space using triangulation when there are at least two cameras (with a known distance between them). Alternatively, or in addition, a variety of depth sensors can be used for calculating the pointed-at location in space.

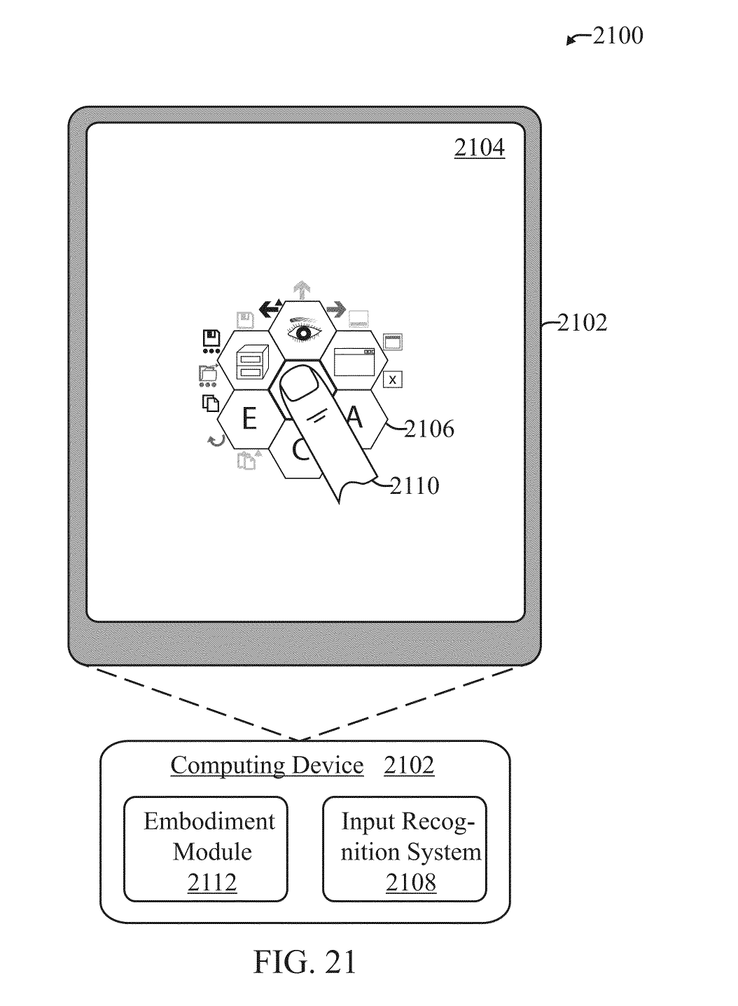

FIG. 21 illustrates an example environment 2100 in accordance with an example of the invention. The example environment 2100 includes a computing device 2102. The computing device 2102 includes a screen 2104, which is touch-sensitive. The screen 2104 displays, in this illustration, the root menu 2106. The computing device 2102 includes an input recognition system 2108 for recognizing a touch input. An operator can provide the touch input by a finger 2110. The touch input is used by an embodiment module 2112, which represents the functionality in accordance with an example of the invention.

Software, hardware, firmware, or any combination thereof can be used for implementing the embodiment module 2112. The embodiment module 2112 can be partly, or wholly, implemented in one or more servers which are in connection with the computing device 2102 via a communication link. The computing device 2102 can be, for example, any of the following, but not limited to: a computer (such as tablet computer, laptop computer, notebook computer, and so on), a mobile phone, an e-book device, a camera, or an entertainment appliance. The computing device 2102 can have access to computer-readable media. Computer-readable media, which can be non-transitory, can include instructions for the embodiment module 2112. The instructions can be stored in one or more memory components. Examples of memory components are non-volatile memory (ROM, EPROM, EEPROM, flash memory, and so on), random access memory (RAM), and a disk storage device (a hard disk drive, CD, DVD, and so on). One or more processors perform processing as instructed by the instructions. The interconnection between one or more memory components and one or more processors, for transferring the instructions and data, typically consists of electrical conductors, known as buses (such as data bus, address bus, and control bus). A system clock causes transferring to take place in an orderly manner and with specific timing.

FIG. 22 illustrates how an operator can indicate whether the movement trajectory begins with scope selection in accordance with an example of the invention. Panning (or scrolling) a document on a touch screen is commonly performed by varying pointed-at location. That is, for example, setting a finger (or a pointing device) in contact with the touch screen and moving the finger relative to the touch screen while a viewing window (what is seen about the document on the touch-screen) is moved along with, or relative to, the finger. This is an intuitive way to perform panning because there are analogues in interaction with physical objects, think, for example, moving a paper on a slippery surface by a finger. This analogue can be continued by adding another task as follows. If you want to draw something when a paper is on a slippery surface, you hold the paper still with other hand, or with other finger. Such an intuitive gesture can be utilized in accordance with an example of the invention, as illustrated in FIG. 22. More specifically, when an operator is holding a computing device 2200 having a touch screen 2202, the operator can easily touch the touch screen 2202 with a thumb 2204 while drawing a movement trajectory (beginning from 2206) with a finger 2208. Because the hand 2210 is holding the computing device 2200, the operator can easily hold the thumb 2204 in a constant location on the touch screen 2202 (at least in steady environment). Furthermore, because the intention of the operator is to hold the viewing window still, it is more intuitive for the operator to hold the thumb 2204 in a constant location. A constant location of one of the touches relative to a touch-screen can be used to distinguish “the holding still gesture” (as herein described) from other multi-touch gestures in accordance with an example of the invention. In addition, the following information can be used for distinguishing the holding still gesture: the touch, which has constant location, is rather elongated and its other end is next to the edge of the touch screen (as it is illustrated with the contacting area 2212, representing a touch). The contacting areas 2212 and 2214 (visualized with gray and representing the parts of fingers in contact with the touch screen 2202) can be sensed by means of resistance or capacitance, for example. If environment can be unsteady, it is convenient to accept a little variation in constant location. If the operator doesn't want to begin with scope selection, the operator doesn't perform the holding still gesture (for example by lifting the thumb 2204 up from the touch screen 2202 or by keeping it outside of the touch screen 2202). The holding still gesture can be used for the other purposes also, such as indicating whether the operator wants to pan or draw.

In accordance with an example of the invention, when an operator indicates with one touch (which fulfills the requirements for the holding still gesture as described just above) that movement trajectory begins with a scope selection, a movement trajectory can begin from the location of another touch at the time of the fulfillment. In addition, if there isn't another touch at the time of the fulfillment, a movement trajectory can begin from the location at which another touch becomes detected. Furthermore, after scope selection is indicated, the operator can switch between scrolling and scope selection by performing the holding still gesture at scope selection and not performing it at scrolling. Alternatively, or in addition, the scroll can be automatic if another touch is close to the edge of the viewing window. These ways enables the operator to perform a scope selection which continues beyond the viewing window at the time of beginning of the scope selection. Furthermore, the operator can end the scope selection and begin a command phase by performing a reversal. The operator can continue the movement trajectory illustrated in FIG. 21 by performing a reversal, when “A sentence to be selected.” becomes selected (the scope selection scheme is based on crossing in this example) and a root menu becomes displayed (from where the operator can continue as described in accordance with an example of the invention, such as selecting Edit>Copy as illustrated in FIG. 13B).

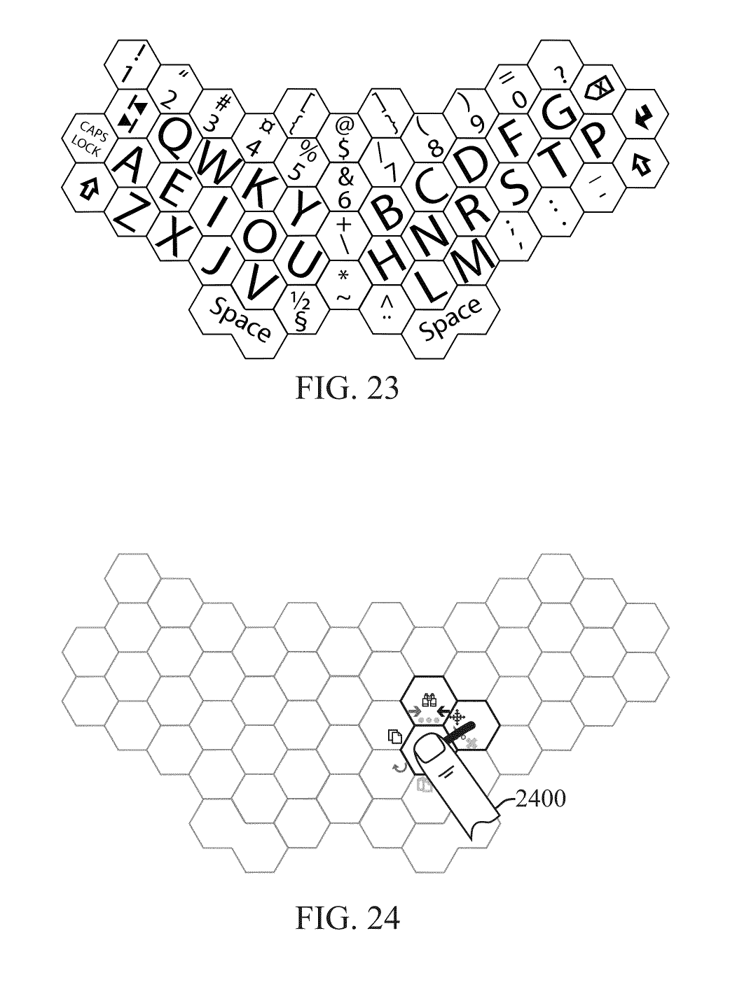

FIG. 23 illustrates a layout for selecting characters and commands in accordance with an example of the invention. The layout comprises tessellated hexagons (excluding the areas for spaces at the bottom of the layout). The layout is designed so that the fingers from the little finger to the index finger of the left hand are commonly hold over letters A, E, I, and O whereas the fingers from the index finger to the little finger of the right hand are commonly hold over letters N, R, S, and T. In addition, thumbs are commonly held over the areas for spaces at the bottom of the layout. When considering written English, A, E, I, and O are the most common vowels and whereas N, R, S, and T are the most common consonants. These eight letters along with space account as much as 70% selection in written English and, therefore, the most of the selecting an operator can perform without moving fingers when using the layout (the design can be redesigned for the other languages). Commonly a vowel is followed by a consonant or space and a consonant is followed by a vowel or space. This is taken into account in the layout because the right hand is selecting only consonants and the left hand is selecting all the vowels along with infrequent consonants, helping to keep rhythm between two hands. In addition, dividing vowels and consonants this way would help learning the layout (as would do locally present alphabetical orders, see FIG. 23). Notice that the row containing the most common vowels forms angle to the row containing the most common consonants. This way the operator can select characters without pending wrists, providing comfort to the operator. Notice also that because the contacting area a finger forms on a surface (when pressed against the surface) is more round than square, hexagon provides more tight fit around the contacting area, enabling more compact layout.

As described above along with the novice mode of command phase, a control element involved in a command selection becomes crossed. That is a distinguishable event from jumping over the control element, or tapping within the area surrounded by a group of control elements. Therefore, tapping within surrounded areas can be used, for example, for adding a character to the text currently written. This paradigm can be seen from different perspective when considering the layout illustrated in FIG. 23. That is, when excluding the areas for spaces at the bottom of the layout, each “distinct area” can be distinguished by a group of central control elements surrounding the distinct area. Furthermore, each such a group of central control elements can be a visual part of different root menus in the layout wherein the rest of the root menu becomes displayed when a “menu condition” becomes fulfilled (see examples below). In other words, a menu (enabling selection of a plurality of commands) and one or more characters can be associated with a distinct area in accordance with an example of the invention. Furthermore, an operator can select either association because of distinguishable events (for example, crossing one of the central control elements surrounding the distinct area by a movement trajectory originating from the distinct area versus tapping within the distinct area).

Associating different root menus with different distinct areas effectively multiplies the possibilities (as described above along with command phase, such as the number of commands possible to select with a particular arrangement of control elements in novice mode or the number of expert trajectories for the most commonly-used commands in expert mode) with the number of distinct areas in a layout. Such a vast number of commands are not required to select in many embodiments and, therefore, only the distinct areas in the middle rows can be used for associations, or only the distinct areas over which the fingers are commonly hold. However, if more root menus are needed to be associated than there are distinct areas in a layout, different root menus can be associated with each combination of a distinct area and a finger wherein the finger becomes determined by which finger the distinct area is touched (similar association is possible with characters).

The character associated with a distinct area can be used as a mnemonic for the root menu associated with the distinct area in accordance with an example of the invention. For example, the root menu for an application can be associated with the same distinct area as character “A” (the first letter of word “application”) and the root menu for the system can be associated with the same distinct area as character “S” (the first letter of word “system”).

FIG. 24 illustrates the beginning of a command selection with the layout illustrated in FIG. 23 in accordance with an example of the invention. In the example illustrated in FIG. 24, the root menu, as illustrated in FIG. 12, is associated with the same distinct area as character “N” is associated (no obvious mnemonic in this example) because then a movement trajectory becomes performed conveniently with an index finger (the index finger is commonly hold over the character “N”). In the situation illustrated in FIG. 24, the central control element with which the Edit top item is associated is crossed by the movement trajectory (performed by finger 2400) originating from the particular distinct area. In other words, the crossed central control element is one of the central control elements which surround the particular distinct area. Because the first crossing has been performed, Edit menu is displayed as illustrated (enabling selection of, for example, Edit>Copy by continuing the movement trajectory correctly). The gray lines in FIG. 24 represent the location of the layout (see FIG. 23) in relative to Edit menu. A computing device can comprise the layout. Also other devices, which don't have embedded computing means, can comprise the layout because required computing can be done in a computing device connected to the device by connecting means.

In accordance with an example of the invention, there are various ways to distinguish a tapping event and to determine when the menu condition is fulfilled. For example, if a moment trajectory has zero length, it can be distinguished as a tapping event. A movement trajectory having zero length can be performed by setting down (beginning the movement trajectory) and lifting up (ending the movement trajectory) a finger at the same location without moving the finger in between. Alternatively, a movement trajectory can be distinguished as a tapping event if the time gap between the beginning and the ending of the movement trajectory having zero length is less than a threshold time. Alternatively, a little spatial variation can be accepted in a tapping event if any central control elements don't become crossed. More specifically, if the length of a movement trajectory is less than a threshold length and if any central control elements don't become crossed, the movement trajectory can be distinguished as a tapping event. On the other hand, if the time gap is more than the threshold time or if the length is more than the threshold length, the menu condition can be determined as fulfilled (which can be incorporated with requirement that only one finger is touching a surface). Exceeding the both thresholds, the threshold time and the threshold length, can be monitored concurrently. Notice that whenever the menu condition becomes fulfilled, or the associated menu becomes displayed, selection of the associated character is no longer possible without additional means (for example, lifting finger up first and then performing subsequent tapping). The both thresholds can be predetermined, they can be adjusted by monitoring an operator, and/or the operator can modify them at will. Distinguishing a tapping event can incorporate information from other sensors as well, such as information from a MEMS motion sensor (tapping will introduce short movements to a device).

In order to select a command in traditional user interface paradigm, an operator makes a round trip to near the screen edge (where command widgets are commonly located) with a mouse cursor. In addition to that round trip, the operator makes a round trip from the keyboard over the mouse and back with a hand in order to move the mouse cursor in traditional user interface paradigm. This is the most typical way operators interact with computers, even there are keyboard shortcuts (which have the problems described above). The both round trips become eliminated in command selection in accordance with an example of the invention, as described along with FIG. 24. This kind of elimination remarkably increases efficiency, especially with applications with which selecting characters and commands are frequently mixed, such as word processors (or text editors) and programming IDEs (Integrated Development Environments).

When the operator perceives a layout by feeling it with fingers, the operator most likely touches the layout simultaneously with many fingers (when the layout can be felt). Therefore, the operator performs several crossings while feeling the layout with many fingers. However, such crossings can be distinguished from the crossings performed with one finger in selection in accordance with an example of the invention (see above how movement trajectory becomes constructed). More specifically, crossings performed with one finger can be distinguished from crossings performed with more than one finger at the same time (such a distinguishing is possible when a computing device has multi-touch capabilities). In addition, if the operator unintentionally crosses a central control element by a movement trajectory performed by one finger, the associated top item becomes selected and the corresponding menu becomes displayed. Then operator will notice the unintentional selection of the top item and can cancel everything simply by lifting finger up before making a subsequent crossing. Notice that selection of the wrong top item doesn't have irreversible consequences in accordance with an example of the invention, as described above.

The location of a finger (such as touched location on a surface) can be sensed with capacitive, resistive, optical or/and acoustic technologies (for example). In addition, the touch of plurality of fingers can be sensed simultaneously. In other words, the touch-sensitive surface can have multi-touch capabilities. The force applied to a surface can be sensed, or surface can be force-sensitive. Furthermore, the force applied to different locations on a surface can be sensed, or a surface can be spatially force-sensitive. Because spatially force-sensitive surface senses the location, it is also touch-sensitive by definition. Spatially force-sensitive surfaces can be capable of detecting one or more touches simultaneously when, for example, the force and the location of several fingers can be sensed simultaneously. The location of applied force by one finger can be sensed with a force-sensitive surface (without being spatially force-sensitive) if the surface is also touch-sensitive because information from two different sensors can be combined.

In accordance with an example of the invention, if enough force is applied to a location within a distinct area with which is associated a character, the character can be added to the text currently written. Such a gesture is intuitive because commonly selecting a character involves applying enough force to an object (think, for example, typing with typewriter). Furthermore, when a character and a root menu is associated with a distinct area (as described above), the end result can depend on the force applied to the distinct area (to be more specific, the sensed force is applied to the sensed location which is within the distinct area) in accordance with an example of the invention. For example, if the force is more than a threshold force, the character can be added to the text currently written, but if the force is less than the threshold force, the root menu can be displayed (another example for the menu condition to become fulfilled). The threshold force can be predetermined, it can be adjusted by monitoring an operator, and/or the operator can modify it at will. Because plurality of distinct areas can be touched simultaneously, it can be required that the root menu becomes displayed when only one finger is touching the surface (such a requirement can be incorporated to the menu condition). The force applied to a surface varies from zero to some value. In terms of detection speed, the varying of the force above zero can be rather smooth because, for example in the case at which the force is applied by a finger, the tissue of a finger is rather elastic. A movement trajectory can begin at the location at which the force is more than zero and end at the location at which the force becomes zero again, and track the location of applied force in between.

As described above in accordance with an example of the invention, an operator can be informed of the existence and the location of control elements using tactile feedback. Such feedback can be provided when different locations can provide different tactile feedbacks and such a feedback is hereafter referred to as “localized tactile feedback”. Furthermore, localized tactile feedback can vary in time in accordance with an example of the invention, and such a feedback is hereafter referred to as “varying localized tactile feedback”. When considering the layout illustrated in FIG. 23, an operator can feel the central control elements surrounding the distinct areas with an example of localized tactile feedback. Such example can comprise physical objects at the locations of central control elements wherein the objects are raised (or depressed) in such way relative to distinct areas that an operator can feel an object (representing a control element) when a part of a finger is touching the object. For example, raised (or depressed) physical objects (representing control elements) can be moved at the level of distinct areas when an operator feels varying localized tactile feedback. Also, distinct areas may be moved (collectively or independently).

There are also other means for providing localized tactile feedback and varying localized tactile feedback in accordance with an example of the invention. For example, such feedbacks can be provided with actuators (such as piezoelectric actuators), with shape-forming materials such as stimulus-active polymers (wherein stimulus can be, for example, electricity, light, magnetic field, and heat), and with electrovibration (wherein, for example, attractive electric Coulomb force is created between a pattern of isolated electrodes and a touching finger). If tactile feedback is provided with electrovibration, especially low frequent (less than 100 Hz) voltage variation in the electrodes representing a control element provides a convenient feedback because then an operator feels the location of the control element as sticky and bumpy.

Varying localized tactile feedback can be used in various ways in accordance with an example of the invention (see the examples of tactile feedback above). For example, after command phase is finished by a reverse crossing, tactile feedback about control elements can be removed and different tactile feedback can be provided in modifying phase. Another example is to provide a regional feedback for the finger by which is applied a force which is more than a threshold force. This way an operator can sense by which finger the threshold force became exceeded. Furthermore, the regional tactile feedback can contain information about selected character (for example, the feedback represents the shape of the character, or the shape of the character from other code, such the one designed for blinds).

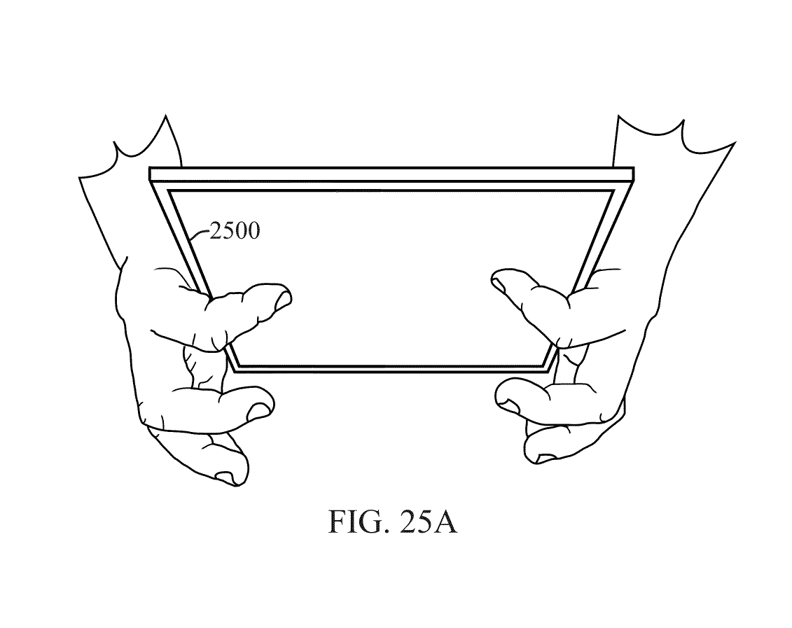

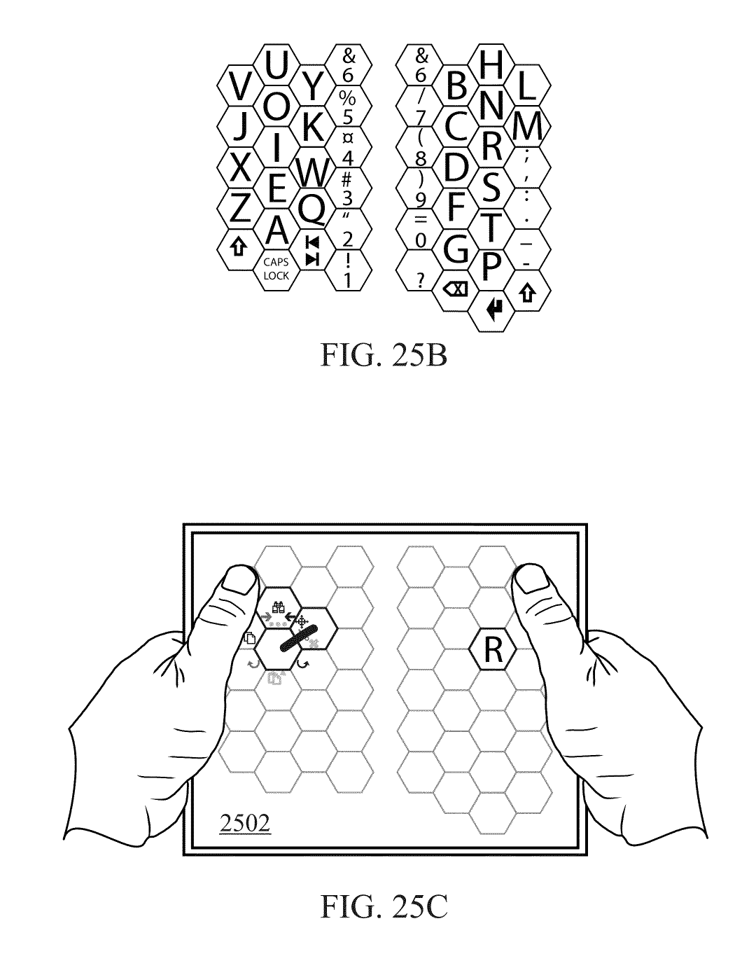

FIG. 25A illustrates a computing device having efficient user interface in accordance with an example of the invention. To begin with, the side an operator normally sees when holding a device conveniently is hereafter referred to as “the front”. The opposite side to the front is hereafter referred to as “the back”. Because the operator normally sees the front, it is convenient to comprise a screen, or screens, at the front. When the operator presses the device from the opposite sides as illustrated in FIG. 25A (the opposite sides are not the front and the back), the device can be held without using fingers. This way the fingers behind the device (all the other fingers than thumbs) can be utilized to the other purpose than holding the device in accordance with an example of the invention, such as performing a movement trajectory on the back or tapping the back.

FIG. 25B illustrates a layout for selecting characters and commands in accordance with an example of the invention. The layout is divided for right and left hands. The layout is designed so that an operator can select letters with same fingers as with the layout illustrated in FIG. 23. The operator can select spaces with thumbs at the front of a device.

The surface 2500 at the back can be touch-sensitive, it can be force-sensitive and it can provide varying localized tactile feedback in accordance with an example of the invention. Furthermore, when an operator touches the back with a finger, the location of the finger can be visualized on the screen 2502 at the front (see FIG. 25C). This way the operator can see the touched locations even when the operator can't see through the computing device. Alternatively, or in addition, the surface 2500 and the screen 2502, and also the part of the computing device in between them, can be transparent (that is, an operator can see through), or regionally transparent. This way the operator can see the locations of the fingers behind the computing device even when these fingers are not touching the surface 2500, which provides more convenient operation. The fingers behind the computing device can be illuminated with a light in dark environment. Then the operator can see the layout against the illuminated fingers. Notice that a touching finger at the back doesn't obstruct anything, as it would be the case with a touch screen.

In accordance with an example of the invention, a transparent screen can be made with OLED (organic light-emitting diode) technology, or with kind of OLED (such as AMOLED, or active-matrix organic light-emitting diode). Furthermore, because some diodes having specific color (such as blue) within a pixel can have more limited lifespan than the others in OLED technology, using such diodes can be avoided in selection of characters and commands in accordance with an example of the invention in order to increase the lifespan of the screen. Furthermore, selection of characters and commands, in accordance with an example of the invention, is energy efficient with the transparent screen because OLEDs can be transparent when not in use (not in use means also less energy consumption). More specifically, only the pixels differing from white (or from another background color) in a layout (see FIG. 25B for example) can be used and such pixels consumes more energy (and the others less). Notice that such pixels can be a fraction of all pixels.

In accordance with an example of the invention, varying localized tactile feedback allows to construct a tactile feedback of the layout at the location where fingers touches the back, or at the closest location at which the control elements (and other components) of the layout can be constructed at full. Then adjustment of the locations of fingers, which could require tedious relocating of the device in relative to hands, is minimized. Index fingers can be used as reference points in constructing.

In accordance with an example of the invention, the menu condition can comprise additional phases. For example, the distinct area, with which the intended root menu is associated, is touched (or pressed with enough force if a surface is force-sensitive) with one finger and a movement trajectory is performed with another finger in such way that the movement trajectory originates from other distinct area, which is hereafter referred to as “the originating distinct area”. In other words, an operator can indicate the intended menu with one finger and perform a movement trajectory with another finger, such as the index finger of the other hand (it can be more convenient to perform a movement trajectory with an index finger). Additionally, the requirement of touching with exactly two fingers (possible for prolonged time) can be incorporated to the menu condition. This kind of additional phase in the menu condition reduces unintentional beginnings of command selections. Furthermore, root menus can be associated with distinct areas which are very close to an edge of an input space (formed by touch-sensitive surface, for example) and movement trajectories can originate enough distance away from the edges of the input space.

Notice that the top items of the intended root menu become temporarily associated with the central control elements surrounding the originating distinct area. In addition, the temporary association can retain equal orientation. In other words, one of the top items of the intended root menu can become selected when the movement trajectory crosses one of the central control elements surrounding the originating distinct area. Subordinate items to the top item are possible to select after selecting the top item.

FIG. 25C illustrates the beginning of a command selection with the computing device and with the layout illustrated in FIG. 25B in accordance with an example of the invention. The root menu, as illustrated in FIG. 12, is associated with the same distinct area as the character “R” is associated. In the situation illustrated in FIG. 25C, two fingers touches the back of the computing device (as illustrated in FIG. 25A) in such way that one index finger touches the right distinct area and the other index finger performs a movement trajectory which originates from the originating distinct area. Using two fingers in such way follows the menu condition described just above. Because the first crossing has been performed, Edit menu is displayed as illustrated (enabling selection of, for example, Edit>Copy by continuing the movement trajectory correctly). The gray lines in FIG. 25C represents the location of the layout (see FIG. 25B) in relative to Edit menu. Notice that selecting characters is possible even with this kind of menu condition. For example, touching a distinct area with one finger and performing crossings with another finger at the same time is distinguishable event from tapping within a distinct area with a finger. Events are also distinguishable if touching and tapping involves a threshold force to be exceeded.

In accordance with an example of the invention, a functional surface (which can be touch-sensitive, spatially force-sensitive and/or provide tactile feedback) at the back may be reduced from those sides which are close to palms towards the center line of the functional surface in order to fit thick components (such as a battery, a camera, a hard disk drive, and so on) at the locations where there isn't such functional surface in terms of a cross-section perpendicular to the back. This kind of reducing helps to design overall thinner computing device because such functional surface can have considerable thickness (in order to provide the functionality, for example). However, this kind of reducing doesn't have disadvantages in terms of convenience (assuming reasonable reducing, possibly decided with help of user tests) because it is inconvenient for an operator to tap, or perform a movement trajectory on, the areas very close to palms at the back when holding the computing device as illustrated with FIG. 25A and FIG. 25C.

The computing device illustrated with FIG. 25A, FIG. 25B, and FIG. 25C may have variety of properties in accordance with an example of the invention. For example, the screen 2502 may be touch-sensitive, force-sensitive and/or it may provide varying localized tactile feedback. In addition, the sides of the computing device an operator presses, or the sides designed to be against palms, may comprise sticky material, such as rubber, in order to more easily hold the computing device. In addition, the sides designed to be against palms may comprise contacting material, such as copper or other metals, in order to ground the operator for better tactile feedback provided with electrovibration. In addition, the back and/or the front may be clickable. In addition, it may be that the computing device folds along a middle line (or along other line) in order to fit to a pocket. Notice that, even the computing device is folded in such way that the screen becomes to inside (which would preserve the screen better from scratches), it can display information to an operator if, for example, it is regionally transparent. In addition, the computing device may comprise properties of mobile phones and/or tablets.

Although embodiments of the invention have been described in language specific to features and/or methods, one of ordinary skill in the art will recognize countless variations and modifications of features from embodiments, combinations of described embodiments and examples which would not depart from the scope of the present invention. Rather, the specific features and methods are disclosed as example implementations of the invention.

1. A method for determining a program flow in response to a movement trajectory of a pointer on a display device, said method comprising the computer implemented steps of:
monitoring whether the movement trajectory contains a reversal and
determining a predetermined program flow based on the reversal after the reversal is found.

2. A method in accordance with claim 1, wherein the monitoring step is executed before the movement trajectory is ended.

3. A method in accordance with claim 2, wherein the predetermined program flow ends a scope selection and begins a command phase if the reversal is found during scope selection phase.

4. A method in accordance with claim 2, wherein the predetermined program flow begins a more precise modifying phase for the currently modified parameter if the reversal is found during modifying phase.

5. A method in accordance with claim 1, wherein the display is a touch screen and said pointer is the input of a touch input on said screen and/or a representation thereof.

6. A method for determining a terminal item of a hierarchical system in response to a movement trajectory of a pointer on a display device, said method comprising the computer implemented steps of:
monitoring a first crossing over a central control element by the movement trajectory,
determining a top item of the hierarchical system based on the first crossing after the first crossing is found,
determining subordinate items to the top item comprising an iteration of the computer implemented steps of:
monitoring whether a selective action occurs,
determining a current item of the hierarchical system based on a way of crossing over a control element in a relation to the selective action after the selective action is found, and
ending the iteration if the current item is a terminal item.

7. A method in accordance with claim 6, wherein the relation is such that the crossing in the way of crossing is a preceding crossing to the selective action.

8. A method in accordance with claim 6, wherein the way of crossing is separated in two ways based on to which side of the control element the movement trajectory ends up after crossing.

9. A method in accordance with claim 8, wherein terminal items of the hierarchical system are computer commands.

10. A method in accordance with claim 6, wherein the central control element is one of a plurality of central control elements, the plurality of central control elements surround the movement trajectory before the first crossing.

11. A method in accordance with claim 6, wherein the selective action is the ending the movement trajectory.

12. A method in accordance with claim 6, wherein the selective action is a reverse crossing.

13. A method in accordance with claim 9, wherein the selective action is a reverse crossing and, if a command becomes determined by the reverse crossing, a modifying phase for the command follows.

14. A method in accordance with claim 6, wherein said pointer is a graphical object controlled by a user input device.

15. A method in accordance with claim 6, wherein the display is a touch screen and said pointer is the input of a touch input on said screen and/or a representation thereof.

16. An electronic device for selecting characters and commands comprising:
a layout comprising a plurality of distinct areas,
means for associating one or more characters and one or more commands with a distinct area, the distinct area is one of the plurality of distinct areas,
means for detecting one or more pointed-at locations in the input of the electronic device, and
means for distinguishing, when a pointed-at location is within the distinct area, character selecting events from command selecting events in such a way that distinguishing is based on the information describing whether a movement trajectory beginning within an originating distinct area exits the originating distinct area.

17. An electronic device in accordance with claim 16, further comprising means for determining a top item of a hierarchical system based on the first crossing by the movement trajectory over one of the central control elements surrounding the originating distinct area, wherein the one or more commands are organized into a hierarchical system and the top items of the hierarchical system are temporarily associated with the central control elements surrounding the originating distinct area.

18. An electronic device in accordance with claim 16, wherein the means for distinguishing comprise such requirement for the command selecting events in terms of detected pointed-at locations that two simultaneous pointed-at locations are allowed when the movement trajectory exits the originating distinct area.

19. An electronic device in accordance with claim 16, wherein the name representing the one or more commands comprises a letter which is equal with a character in the one or more characters.

20. An electronic device in accordance with claim 16, wherein the input of the electronic device comprises a touch-sensitive surface capable of detecting one or more touches, the touch-sensitive surface comprises the layout in the input space of the touch-sensitive surface.

21-140. (canceled)
